(19) United States
(12) Patent Application Publication
(10) Pub. No.: US 2025/0317944 A1
(43) Pub. Date: Oct. 9, 2025

(54) SIDELINK COMMUNICATION USING FIXED FRAME PERIODS

(71) Applicant: QUALCOMM INCORPORATED, San Diego, CA (US)

(72) Inventors: Luanxia Yang, Beijing (CN); Changlong Xu, Beijing (CN); Jing Sun, San Diego, CA (US); Chih-Hao Liu, San Diego, CA (US); Xiaoxia Zhang, San Diego, CA (US); Shaozhen Guo, Beijing (CN); Siyi Chen, Beijing (CN); Hao Xu, Beijing (CN)

(21) Appl. No.: 18/864,164

(22) PCT Filed: Jun. 21, 2022
(86) PCT No.: PCT/CN2022/100044

§ 371 Date: Nov. 8, 2024

(51) Int. Cl. H04W 72/25; H04W 74/0816

(52) U.S. Cl. CPC H04W 72/25; H04W 74/0816

(57) ABSTRACT

Methods, systems, and devices for wireless communications are described. A first user equipment (UE) may be configured with a timing of a frame structure for sidelink communications via a shared channel. The timing of the frame structure may correspond to a fixed frame period (FFP), and the first UE may initiate sidelink communications at the boundaries of the FFPs. The first UE may also support techniques for determining whether to initiate a channel access procedure to occupy a shared channel during a first FFP. In one example, the first UE may determine whether to initiate the channel access procedure to occupy the shared channel during the first FFP based on monitoring the shared channel during a second FFP for a sidelink transmission from a second UE. In another example, the first UE may receive an indication of whether to initiate the channel access procedure during the first FFP.

### CROSS REFERENCE

The present application is a 371 national stage filing of International PCT Application No. PCT/CN2022/100044 by Yang et al. entitled “SIDELINK COMMUNICATION USING FIXED FRAME PERIODS,” filed Jun. 21, 2022, which is assigned to the assignee hereof, and which is expressly incorporated by reference in its entirety herein.

### FIELD OF TECHNOLOGY

The following relates to wireless communications, including sidelink communication using fixed frame periods.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Some wireless communications systems may support sidelink communications between UEs in a shared radio frequency spectrum. The shared radio frequency spectrum may be a spectrum that is unlicensed, licensed to multiple operators, or licensed to a single operator with opportunistic access by other devices (e.g., a licensed radio frequency spectrum, an unlicensed radio frequency spectrum, or a combination of licensed and unlicensed radio frequency spectrum). Improved techniques for facilitating sidelink communications in a shared radio frequency spectrum may be desirable.

### SUMMARY

The described techniques relate to improved methods, systems, devices, and apparatuses that support sidelink communication using fixed frame periods. A first user equipment (UE) may be configured with a timing of a frame structure for sidelink communications via a shared channel. The timing of the frame structure may correspond to a fixed frame period (FFP), and the first UE may initiate sidelink communications at the boundaries of the FFPs. The first UE may also support techniques for determining whether to initiate a channel access procedure to occupy a shared channel during a first FFP. In one example, the first UE may determine whether to initiate the channel access procedure to occupy the shared channel during the first FFP based on monitoring the shared channel during a second FFP for a sidelink transmission from a second UE. In another example, the first UE may receive an indication of whether to initiate the channel access procedure during the first FFP.

A method for wireless communication at a first user equipment (UE) is described. The method may include identifying sidelink data to transmit in a first frame period of a set of multiple frame periods having fixed frame durations established for communication by the first UE via a shared channel, determining whether to initiate a channel access procedure to occupy the shared channel for the first frame period, and transmitting the sidelink data based on the determining.

An apparatus for wireless communication at a first UE is described. The apparatus may include a processor, memory coupled with the processor, and instructions stored in the memory. The instructions may be executable by the processor to cause the apparatus to identify sidelink data to transmit in a first frame period of a set of multiple frame periods having fixed frame durations established for communication by the first UE via a shared channel, determine whether to initiate a channel access procedure to occupy the shared channel for the first frame period, and transmit the sidelink data based on the determining.

Another apparatus for wireless communication at a first UE is described. The apparatus may include means for identifying sidelink data to transmit in a first frame period of a set of multiple frame periods having fixed frame durations established for communication by the first UE via a shared channel, means for determining whether to initiate a channel access procedure to occupy the shared channel for the first frame period, and means for transmitting the sidelink data based on the determining.

A non-transitory computer-readable medium storing code for wireless communication at a first UE is described. The code may include instructions executable by a processor to identify sidelink data to transmit in a first frame period of a set of multiple frame periods having fixed frame durations established for communication by the first UE via a shared channel, determine whether to initiate a channel access procedure to occupy the shared channel for the first frame period, and transmit the sidelink data based on the determining.

Some examples of the method, apparatuses, and non-transitory computer-readable medium described herein may further include operations, features, means, or instructions for monitoring the shared channel during a second frame period of the set of multiple frame periods for a sidelink transmission from a second UE, where determining whether to initiate the channel access procedure to occupy the shared channel during the first frame period may be based on the monitoring.

In some examples of the method, apparatuses, and non-transitory computer-readable medium described herein, determining whether to initiate the channel access procedure to occupy the shared channel during the first frame period may include operations, features, means, or instructions for detecting the sidelink transmission from the second UE based on the monitoring, determining to share a channel occupancy time initiated by the second UE including the second frame period based on detecting the sidelink transmission, and refraining from initiating the channel access procedure to occupy the shared channel during the first frame period based on determining to share the channel occupancy time initiated by the second UE.

Some examples of the method, apparatuses, and non-transitory computer-readable medium described herein may further include operations, features, means, or instructions for receiving, in the sidelink transmission, an indication that the sidelink transmission may be from the second UE, where detecting the sidelink transmission from the second UE may be based on receiving the indication.

In some examples of the method, apparatuses, and non-transitory computer-readable medium described herein, determining whether to initiate the channel access procedure to occupy the shared channel during the first frame period may include operations, features, means, or instructions for determining to initiate the channel access procedure to occupy the shared channel during the first frame period based on failing to detect the sidelink transmission from the second UE.

Some examples of the method, apparatuses, and non-transitory computer-readable medium described herein may further include operations, features, means, or instructions for receiving, from a network entity, the second UE, or a third UE, an indication of a configuration of the second frame period and identifying a starting boundary of the second frame period based on receiving the indication of the configuration of the second frame period, where the monitoring for the sidelink transmission from the second UE may be based on identifying the starting boundary of the second frame period.

In some examples of the method, apparatuses, and non-transitory computer-readable medium described herein, the sidelink transmission from the second UE includes a data transmission or a sharing information transmission.

Some examples of the method, apparatuses, and non-transitory computer-readable medium described herein may further include operations, features, means, or instructions for receiving, in downlink control information from a network entity, an indication of whether to initiate the channel access procedure to occupy the shared channel during the first frame period or share a channel occupancy time initiated by a second UE.

Some examples of the method, apparatuses, and non-transitory computer-readable medium described herein may further include operations, features, means, or instructions for receiving, in a groupcast transmission from a second UE, an indication of whether to initiate the channel access procedure to occupy the shared channel during the first frame period or share a channel occupancy time initiated by a third UE.

In some examples of the method, apparatuses, and non-transitory computer-readable medium described herein, the groupcast transmission includes a bitmap, and a bit or time indicator in the bitmap for the first UE indicates whether the first UE may be to initiate the channel access procedure to occupy the shared channel during the first frame period or share the channel occupancy time initiated by the third UE.

In some examples of the method, apparatuses, and non-transitory computer-readable medium described herein, the groupcast transmission includes a field including an identifier of the first UE and an indication of whether the first UE may be to initiate the channel access procedure to occupy the shared channel during the first frame period or share the channel occupancy time initiated by the third UE.

Some examples of the method, apparatuses, and non-transitory computer-readable medium described herein may further include operations, features, means, or instructions for receiving, in a unicast transmission from a second UE, an indication of whether to initiate the channel access procedure to occupy the shared channel during the first frame period or share a channel occupancy time initiated by the second UE.

A method for wireless communication at a wireless device is described. The method may include identifying respective traffic patterns associated with a plurality of UEs, determining, based on the respective traffic patterns of the plurality of UEs, whether each UE of the plurality of UEs is to initiate a channel access procedure to occupy a shared channel during a first frame period of a set of multiple frame periods having fixed frame durations established for communication with the plurality of UEs, and transmitting, to the each UE, an indication of whether to initiate the channel access procedure to occupy the shared channel during the first frame period based on the determining.

An apparatus for wireless communication at a wireless device is described. The apparatus may include a processor, memory coupled with the processor, and instructions stored in the memory. The instructions may be executable by the processor to cause the apparatus to identify respective traffic patterns associated with a plurality of UEs, determine, based on the respective traffic patterns associated with the plurality of UEs, whether each UE of the plurality of UEs is to initiate a channel access procedure to occupy a shared channel during a first frame period of a set of multiple frame periods having fixed frame durations established for communication with the plurality of UEs, and transmit, to each UE, an indication of whether to initiate the channel access procedure to occupy the shared channel during the first frame period based on the determining.

Another apparatus for wireless communication at a wireless device is described. The apparatus may include means for identifying respective traffic patterns associated with a plurality of UEs, means for determining, based on the respective traffic patterns associated with the plurality of UEs, whether each UE of the plurality of UEs is to initiate a channel access procedure to occupy a shared channel during a first frame period of a set of multiple frame periods having fixed frame durations established for communication with the plurality of UEs, and means for transmitting, to the each UE, an indication of whether to initiate the channel access procedure to occupy the shared channel during the first frame period based on the determining.

A non-transitory computer-readable medium storing code for wireless communication at a wireless device is described. The code may include instructions executable by a processor to identify respective traffic patterns associated with a plurality of UEs, determine, based on the respective traffic patterns associated with the multiple UEs, whether each UE of the multiple UEs is to initiate a channel access procedure to occupy a shared channel during a first frame period of a set of multiple frame periods having fixed frame durations established for communication with the plurality of UEs, and transmit, to each UE, an indication of whether to initiate the channel access procedure to occupy the shared channel during the first frame period based on the determining.

In some examples of the method, apparatuses, and non-transitory computer-readable medium described herein, transmitting the indication of whether to initiate the channel access procedure to occupy the shared channel during the first frame period may include operations, features, means, or instructions for transmitting, in downlink control information, the indication of whether to initiate the channel access procedure to occupy the shared channel during the first frame period or share a channel occupancy time initiated by another UE.

In some examples of the method, apparatuses, and non-transitory computer-readable medium described herein, transmitting the indication of whether to initiate the channel access procedure to occupy the shared channel during the first frame period may include operations, features, means, or instructions for transmitting, in a groupcast transmission, an indication of whether to initiate the channel access procedure to occupy the shared channel during the first frame period or share a channel occupancy time initiated by another UE.

In some examples of the method, apparatuses, and non-transitory computer-readable medium described herein, the groupcast transmission includes a bitmap, and each bit in the bitmap indicates whether a corresponding UE may be to initiate the channel access procedure to occupy the shared channel during the first frame period or share a channel occupancy time initiated by another UE.

In some examples of the method, apparatuses, and non-transitory computer-readable medium described herein, the groupcast transmission includes a bitmap, and a time indicator in the bitmap indicates whether a corresponding UE may be to initiate the channel access procedure to occupy the shared channel during each of one or more frame periods including the first frame period or share channel occupancy times initiated by other UEs.

In some examples of the method, apparatuses, and non-transitory computer-readable medium described herein, the groupcast transmission includes a field including an identifier of each UE and an indication of whether the each UE may be to initiate the channel access procedure to occupy the shared channel during the first frame period or share a channel occupancy time with another UE.

In some examples of the method, apparatuses, and non-transitory computer-readable medium described herein, transmitting the indication of whether to initiate the channel access procedure to occupy the shared channel during the first frame period may include operations, features, means, or instructions for transmitting, to each UE in a unicast transmission, an indication of whether to initiate the channel access procedure to occupy the shared channel during the first frame period or share a channel occupancy time initiated by another UE.

A method for wireless communication at a first UE is described. The method may include identifying, at the first UE, a configuration of a timing of a frame structure for sidelink communication via a shared channel, where the frame structure includes a set of multiple frame periods having a fixed frame duration and communicating during one or more of the set of multiple frame periods of the frame structure in accordance with the configuration.

An apparatus for wireless communication at a first UE is described. The apparatus may include a processor, memory coupled with the processor, and instructions stored in the memory. The instructions may be executable by the processor to cause the apparatus to identify, at the first UE, a configuration of a timing of a frame structure for sidelink communication via a shared channel, where the frame structure includes a set of multiple frame periods having a fixed frame duration and communicate during one or more of the set of multiple frame periods of the frame structure in accordance with the configuration.

Another apparatus for wireless communication at a first UE is described. The apparatus may include means for identifying, at the first UE, a configuration of a timing of a frame structure for sidelink communication via a shared channel, where the frame structure includes a set of multiple frame periods having a fixed frame duration and means for communicating during one or more of the set of multiple frame periods of the frame structure in accordance with the configuration.

A non-transitory computer-readable medium storing code for wireless communication at a first UE is described. The code may include instructions executable by a processor to identify, at the first UE, a configuration of a timing of a frame structure for sidelink communication via a shared channel, where the frame structure includes a set of multiple frame periods having a fixed frame duration and communicate during one or more of the set of multiple frame periods of the frame structure in accordance with the configuration.

In some examples of the method, apparatuses, and non-transitory computer-readable medium described herein, identifying the configuration of the timing of the frame structure may include operations, features, means, or instructions for receiving, from a network entity or a second UE, an indication of the configuration of the timing of the frame structure.

In some examples of the method, apparatuses, and non-transitory computer-readable medium described herein, the configuration of the timing of the frame structure may be preconfigured at the first UE.

Some examples of the method, apparatuses, and non-transitory computer-readable medium described herein may further include operations, features, means, or instructions for identifying the configuration of the timing of the frame structure based on a traffic pattern at the first UE.

A method for wireless communication at a wireless device is described. The method may include identifying, based on a traffic pattern associated with a first UE, a timing of a frame structure for sidelink communication at the first UE via a shared channel, where the frame structure includes a set of multiple frame periods having a fixed frame duration and transmitting, to the first UE, an indication of a configuration of the timing of the frame structure.

An apparatus for wireless communication at a wireless device is described. The apparatus may include a processor, memory coupled with the processor, and instructions stored in the memory. The instructions may be executable by the processor to cause the apparatus to identify, based on a traffic pattern associated with a first UE, a timing of a frame structure for sidelink communication at the first UE via a shared channel, where the frame structure includes a set of multiple frame periods having a fixed frame duration and transmit, to the first UE, an indication of a configuration of the timing of the frame structure.

Another apparatus for wireless communication at a wireless device is described. The apparatus may include means for identifying, based on a traffic pattern associated with a first UE, a timing of a frame structure for sidelink communication at the first UE via a shared channel, where the frame structure includes a set of multiple frame periods having a fixed frame duration and means for transmitting, to the first UE, an indication of a configuration of the timing of the frame structure.

A non-transitory computer-readable medium storing code for wireless communication at a wireless device is described. The code may include instructions executable by a processor to identify, based on a traffic pattern associated with a first UE, a timing of a frame structure for sidelink communication at the first UE via a shared channel, where the frame structure includes a set of multiple frame periods having a fixed frame duration and transmit, to the first UE, an indication of a configuration of the timing of the frame structure.

In some examples of the method, apparatuses, and non-transitory computer-readable medium described herein, the wireless device includes a network entity and the method, apparatuses, and non-transitory computer-readable medium may include further operations, features, means, or instructions for determining the traffic pattern associated with the first UE based on sidelink communication scheduled at the first UE by the network entity.

In some examples of the method, apparatuses, and non-transitory computer-readable medium described herein, the wireless device includes a second UE and the method, apparatuses, and non-transitory computer-readable medium may include further operations, features, means, or instructions for receiving, from a network entity or from the first UE, an indication of the traffic pattern at the first UE.

In some examples of the method, apparatuses, and non-transitory computer-readable medium described herein, the wireless device includes a second UE, and the second UE includes an anchor UE that may be preconfigured, configured via signaling from a network entity, or selected by one or more UEs including the first UE.

### BRIEF DESCRIPTION OF THE DRAWINGS

FIG. 1 illustrates an example of a wireless communications system that supports sidelink communication using fixed frame periods in accordance with one or more aspects of the present disclosure.

FIG. 2 illustrates an example of fixed frame periods (FFPs) in accordance with one or more aspects of the present disclosure.

FIG. 3 illustrates an example of an FFP structure for sidelink communications in a shared spectrum in accordance with one or more aspects of the present disclosure.

FIG. 4 illustrates an example of a wireless communications system that supports sidelink communication using fixed frame periods in accordance with one or more aspects of the present disclosure.

FIG. 5 illustrates an example of channel occupancy time (COT) sharing in accordance with one or more aspects of the present disclosure.

FIG. 6 illustrates an example of an initialization of a channel access procedure in accordance with one or more aspects of the present disclosure.

FIG. 7 illustrates an example of groupcast transmissions indicating whether each user equipment (UE) of multiple UEs is to initiate a channel access procedure to occupy a shared channel in an FFP in accordance with one or more aspects of the present disclosure.

FIG. 8 illustrates an example of a process flow that supports sidelink communication using fixed frame periods in accordance with one or more aspects of the present disclosure.

FIGS. 9 and 10 show block diagrams of devices that support sidelink communication using fixed frame periods in accordance with one or more aspects of the present disclosure.

FIG. 11 shows a block diagram of a communications manager that supports sidelink communication using fixed frame periods in accordance with one or more aspects of the present disclosure.

FIG. 12 shows a diagram of a system including a device that supports sidelink communication using fixed frame periods in accordance with one or more aspects of the present disclosure.

FIGS. 13 and 14 show block diagrams of devices that support sidelink communication using fixed frame periods in accordance with one or more aspects of the present disclosure.

FIG. 15 shows a block diagram of a communications manager that supports sidelink communication using fixed frame periods in accordance with one or more aspects of the present disclosure.

FIG. 16 shows a diagram of a system including a device that supports sidelink communication using fixed frame periods in accordance with one or more aspects of the present disclosure.

FIGS. 17 through 20 show flowcharts illustrating methods that support sidelink communication using fixed frame periods in accordance with one or more aspects of the present disclosure.

### DETAILED DESCRIPTION

Some wireless communications systems may support sidelink communications between user equipments (UEs) in a shared spectrum (e.g., shared radio frequency spectrum). In such systems, a UE communicating over a sidelink may support a load based equipment (LBE) mode or an FBE mode. In an LBE mode, a UE may contend for access to a shared channel at any time to transmit sidelink data over the shared channel. In an FBE mode, a UE may contend for access to a shared channel at fixed times to transmit sidelink data over the shared channel. For instance, in the FBE mode, the UE may be configured with fixed frame periods (FFPs), and the UE may contend for access to a shared channel at the boundary of an FFP to transmit sidelink data in the FFP. In some cases, however, techniques for configuring a timing of a frame structure for sidelink communications over a shared channel may be undefined. Further, in an FBE system, techniques at a UE for contending for access to a shared channel at the boundary of FFPs may be deficient.

As described herein, a wireless communications system may support efficient techniques for facilitating sidelink communications in a shared spectrum (e.g., in an FBE system). A first UE may be configured with a timing of a frame structure for sidelink communications via a shared channel. The timing of the frame structure may correspond to an FFP, and the first UE may initiate sidelink communications at the boundaries of the FFPs. The first UE may also support techniques for determining whether to initiate a channel access procedure to occupy a shared channel during a first FFP. In one example, the first UE may determine whether to initiate the channel access procedure to occupy the shared channel during the first FFP based on monitoring the shared channel during a second FFP for a sidelink transmission from a second UE. In another example, the first UE may receive an indication of whether to initiate the channel access procedure during the first FFP.

Aspects of the disclosure are initially described in the context of wireless communications systems. Aspects of the disclosure are further illustrated by and described with reference to apparatus diagrams, system diagrams, and flowcharts that relate to sidelink communication using fixed frame periods.

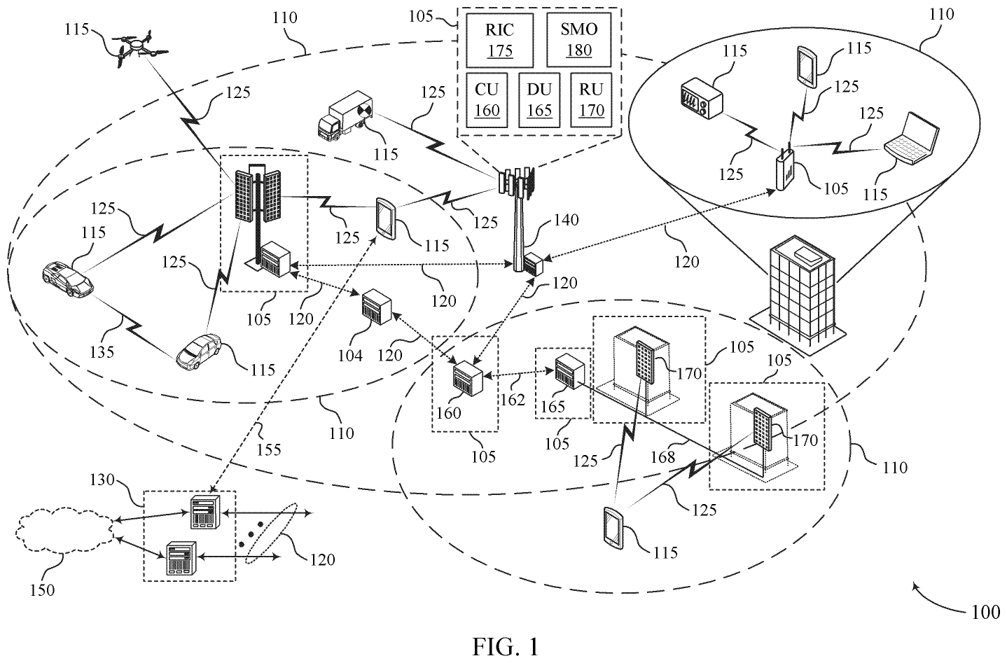

FIG. 1 illustrates an example of a wireless communications system 100 that supports sidelink communication using fixed frame periods in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support sidelink communication using fixed frame periods as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may utilize both unshared (e.g., licensed) and shared (e.g., unlicensed, licensed to more than one operator, licensed to one or more operators with opportunistic use) radio frequency spectrum bands. For example, the wireless communications system 100 may employ License Assisted Access (LAA), LTE-Unlicensed (LTE-U) radio access technology, NR technology in an unlicensed band (NR-U, including sidelink-U) such as the 5 GHz industrial, scientific, and medical (ISM) band. When operating in unlicensed radio frequency spectrum bands, devices such as the network entities 105 and the UEs 115 may employ carrier sensing for collision detection and avoidance. For example, the network entities 105 and the UEs 115 may employ listen-before-talk (LBT) procedures to ensure a frequency channel (e.g., an LBT subchannel or a frequency band that is accessible via an LBT procedure) is clear before transmitting data. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

An LBT procedure may be an example of a channel access procedure. A channel access procedure may include monitoring a channel, determining whether the channel is clear based on the monitoring, and transmitting on the channel if the channel is clear. A device may determine that a channel is clear (e.g., available for use) after monitoring the channel and failing to detect a transmission on the channel or failing to detect a transmission on the channel with a signal strength satisfying a threshold. Alternatively, the device may determine that the channel is not clear (e.g., unavailable for use) after monitoring the channel and detecting one or more transmissions on the channel or detecting one or more transmissions on the channel with signal strengths satisfying a threshold. A UE 115 may initiate a channel access procedure by monitoring a channel for a transmission from another device (e.g., another UE 115 or a network entity 105). In some cases, initiating a channel access procedure may refer to performing the channel access procedure.

In some implementations, there may be different categories of LBT procedures, including category 1 LBT (e.g., no LBT), category 2 LBT (e.g., LBT including one-time channel sensing for a fixed period without a back-off period), category 3 LBT (e.g., LBT with a random (or other) back-off period and a fixed sized contention window), and category 4 LBT (e.g., LBT with a random (or other) back-off period and a variable sized contention window). In some cases, a category 2 LBT procedure may be referred to as a one-time LBT procedure where a UE 115 may perform channel sensing for a defined duration (e.g., 25 μs). Further, a category 4 LBT procedure may be referred to as a fairness-based LBT procedure for performing channel sensing with a backoff, where the backoff may be used to prevent a UE 115 from accessing a channel immediately after detecting that the channel is clear.

The wireless communications system 100 may support sidelink communications between UEs 115 in a shared (e.g., unlicensed) spectrum. Sidelink communications may take place in transmission or reception resource pools. A minimum resource allocation unit for sidelink communications may be a sub-channel in a frequency domain, and a resource allocation in a time domain for sidelink communications may be one slot. Some slots may not be available for sidelink (e.g., a subset of total slots of a carrier may be available for sidelink), and some slots may contain feedback resources. In some aspects, an RRC configuration for sidelink communications may be preconfigured (e.g., preloaded on a UE 115) or signaled to a UE 115 (e.g., from a network entity 105). In some examples, a network entity 105 facilitates the scheduling of resources for sidelink communications (e.g., in a resource allocation mode 1). In other cases, sidelink communications are carried out between the UEs 115 without the involvement of a network entity 105 (e.g., in a resource allocation mode 2).

In some aspects, a UE 115 communicating over a sidelink in a shared spectrum may support an LBE mode or an FBE mode. The UE 115 may receive system information (e.g., remaining minimum system information (RMSI)) from a network entity 105 indicating an FBE mode in which the UE 115 may operate (e.g., a semi-static channel access mode). In an LBE mode, a UE 115 may contend for access to a shared channel at any time to transmit sidelink data over the shared channel. In an FBE mode, a UE 115 may contend for access to a shared channel at fixed times to transmit sidelink data over the shared channel. For instance, in the FBE mode, the UE may be configured with FFPs, and the UE may contend for access to a shared channel at the boundary of an FFP to transmit sidelink data in the FFP. A UE 115 may receive (e.g., in a system information block 1 (SIB1)) an indication of an FFP configuration for the UE 115. The FFP configuration may indicate the FFPs (e.g., the periodicity of radio frames) within which the UE 115 may communicate. In some examples, the FFP configuration may be signaled to the UE 115 with UE-specific RRC signaling (e.g., for an FBE secondary cell (SCell)).

An FFP may include an idle period and a period for transmitting data, and an FFP may be restricted to values of 1 ms, 2 ms, 2.5 ms, 4 ms, 5 ms, and 10 ms (e.g., including the idle period). The starting positions of FFPs within every two radio frames may be from an even radio frame and may be given by i*P, where

$$i = \{ 0 , 1 , … , \frac{20}{P - 1} \}$$

and P is the fixed frame period in ms. The idle period (e.g., in an FFP) for a given subcarrier spacing (SCS) may be equal to

$$⌈ \frac{Minimum idle period allowed by regulations}{Ts} ⌉ ,$$

where a minimum idle period allowed is equal to max (5% of FFP, 100 μs), Ts is a symbol duration for a given SCS, and a physical random access channel (PRACH) resource is considered invalid if it overlaps with an idle period of an FFP when an FBE mode of operation is indicated. Table 1 provides the minimum occupied numbers of symbols for an idle mode in an FFP for different SCSs.

TABLE 1
Minimum occupied numbers of symbols for an
idle period in an FFP for different SCSs

| SCS | The minimum occupied number |
|---|---|
| (kHz) | of symbols for idle |
| 15 | 2 |
| 30 | 3 |
| 60 | 6 |
| 120 | 12 |

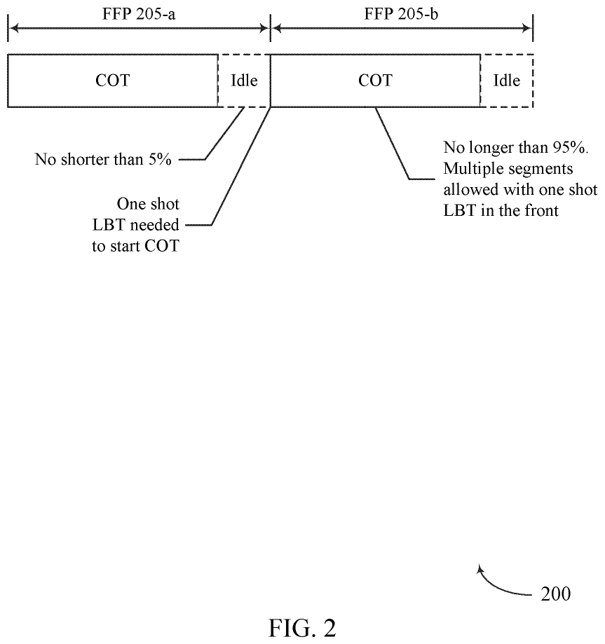

FIG. 2 illustrates an example of FFPs 200 in accordance with one or more aspects of the present disclosure. A first FFP 205-a may include a channel occupancy time (COT) corresponding to a period in the FFP 205-a that a UE 115 may occupy a shared channel for sidelink communications, and the first FFP 205-a may include an idle period. In some examples, a UE 115 may perform a channel access procedure in the idle period of the first FFP 205-a to gain access to the COT of the second FFP 205-b. If the channel access procedure is successful, the UE 115 may transmit sidelink data during the COT of the second FFP 205-b. Otherwise, the UE 115 may avoid occupying the COT of the second FFP 205-b. In some cases, a UE 115 may be configured with one or more FBE channel access rules which may be aligned with any regulations for FBE operation. Table 2 below provides examples of these FBE channel access rules. In some examples, a category 2 LBT for FBE may be different from a category 2 LBT (e.g., 25 μs or 16 μs) in LBE. In such examples, a UE 115 may perform one 9 μs measurement before a transmission with at least 4 μs for a measurement.

TABLE 2
FBE channel access rules

| | Category 1 LBT | Category 2 LBT |
|---|---|---|
| Network entity | N/A | At a fixed |
| to initiate | | location right |
| COT | | before an FFP |
| Network entity | If a gap from a | If a gap from a |
| transmits another | previous downlink | previous downlink |
| downlink burst in | or uplink burst | or uplink burst |
| a COT acquired by | is within 16 μs | is more than 16 μs |
| the network entity | | |
| UE to initiate a COT | N/A | N/A |
| UE to transmit an | If a gap from a | If a gap from a |
| uplink burst in a | previous downlink | previous downlink |
| COT acquired by | or uplink burst | or uplink burst |
| a network entity | is within 16 μs | is more than 16 μs |

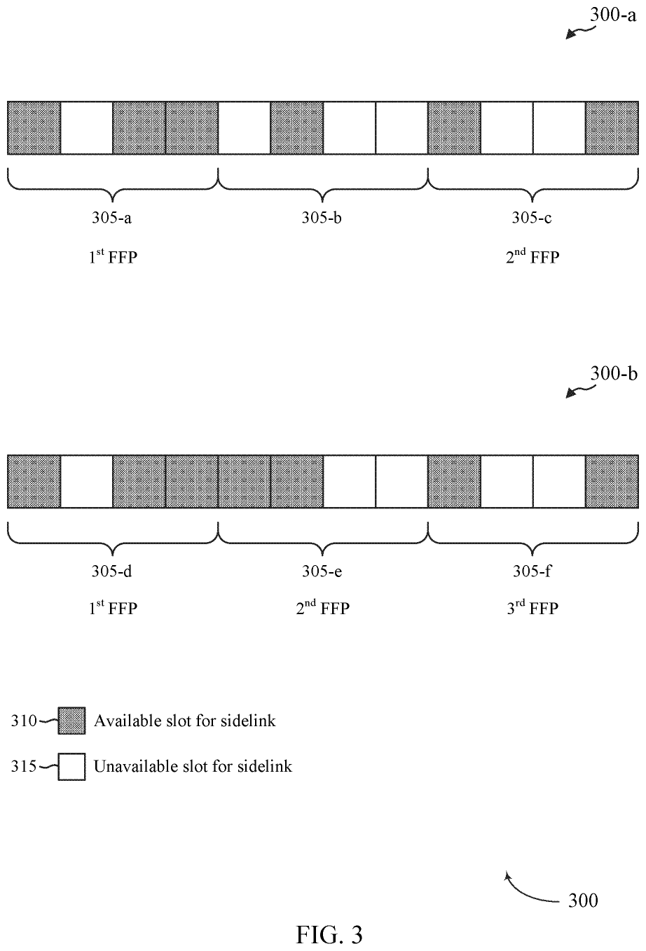

FIG. 3 illustrates an example of an FFP structure 300 for sidelink communications in a shared spectrum in accordance with one or more aspects of the present disclosure. A UE 115 may be configured to communicate using a number of slots, and the UE 115 may be allowed to use a subset of these slots for sidelink communications. The slots configured for communications at the UE 115 may include slots available for sidelink 310 and slots unavailable for sidelink 315 and may be referred to as physical slots, and the slots available for sidelink 310 may be referred to as logical slots. In the example of FIG. 3, a length of an FFP may be configured as 4 physical slots, and an FFP may be 2 ms with an SCS of 30 kHz. In some cases, there may be one or more ways to structure FFPs (e.g., and the alignment of FFPs and logical slots) for sidelink communications in a shared spectrum. An FFP may follow specified values or a subset of these values.

In a first example 300-a, sidelink traffic may not be aligned to the starting point of an FFP. For instance, a first slot available for sidelink in a period 305-b may not be the first slot in the period 305-b. Thus, a UE 115 may not occupy a channel during the period 305-b for sidelink communications. Instead, the UE 115 may occupy a channel during the period 305-a corresponding to a first FFP and the period 305-c corresponding to a second FFP. In a second example 300-b, a resource configuration of a resource pool may be based on an FFP configuration. The resource configuration of the resource pool may ensure that a logical slot is located at an FFP starting point (e.g., a logical slot is the first slot in an FFP). For instance, a first slot in each of the periods 305-d, 305-e, and 305-f may be an available slot for sidelink 310. Thus, a UE 115 may occupy a channel during the period 305-d corresponding to a first FFP, the period 305-e corresponding to a second FFP, and the period 305-f corresponding to a third FFP.

A UE 115 in the wireless communications system 100 may use any of the FFP structures described with reference to FIG. 3 for sidelink communications in a shared spectrum. In some cases, however, techniques for configuring a timing of a frame structure for sidelink communications over a shared channel may be undefined. Further, in an FBE system, techniques at a UE 115 for contending for access to a shared channel at the boundary of FFPs may be deficient. For instance, a UE 115 may be able to initiate a channel access procedure to occupy a shared channel during an FFP or COT, or the UE 115 may be able to share a COT with other devices. However, the behavior of the UE 115 or the specific option for the UE 115 to use for channel access may be undefined. As described herein, the wireless communications system 100 may support efficient techniques for facilitating sidelink communications in a shared spectrum (e.g., in an FBE system).

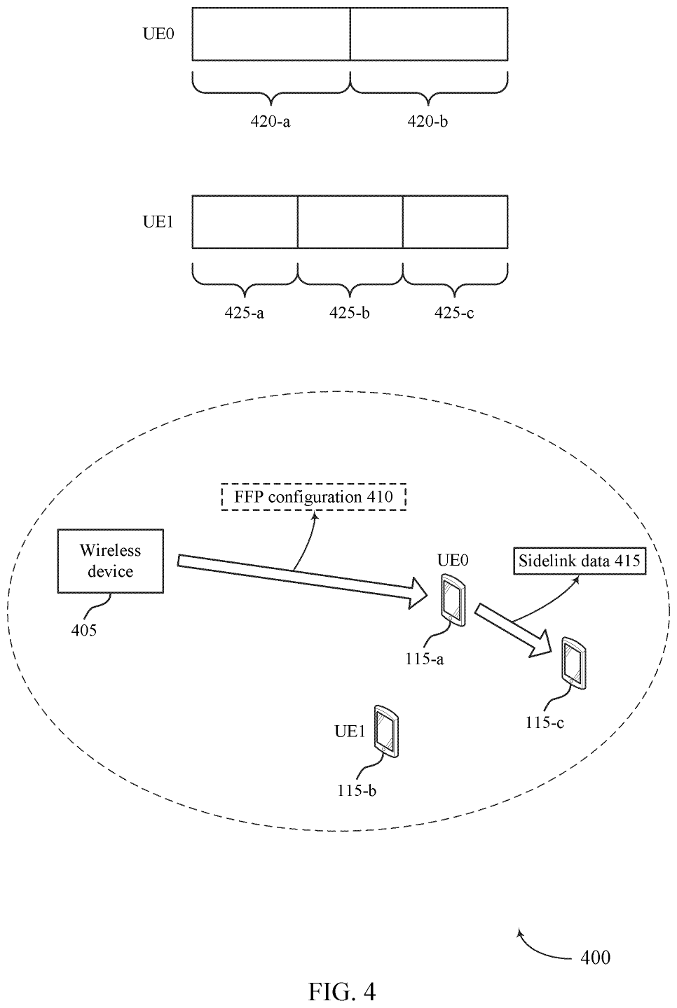

FIG. 4 illustrates an example of a wireless communications system 400 that supports sidelink communication using fixed frame periods in accordance with one or more aspects of the present disclosure. The wireless communications system 400 includes a wireless device 405, which may be an example of a network entity 105 or a UE 115 described with reference to FIGS. 1-3. The wireless communications system 400 also includes a UE 115-a, a UE 115-b, and a UE 115-c, which may be examples of UEs 115 described with reference to FIGS. 1-3. The wireless communications system 400 may implement aspects of the wireless communications system 100. For instance, the wireless communications system 400 may support efficient techniques for facilitating sidelink communications in a shared spectrum (e.g., in an FBE system).

Before communicating with the UE 115-c in a shared channel (e.g. in a shared or unlicensed spectrum), the UE 115-a may identify an FFP configuration for sidelink communications in the shared channel. The FFP configuration may refer to a configuration of a timing of a frame structure for sidelink communications in a shared channel, where the frame structure includes multiple frame periods having a fixed frame duration (e.g., multiple FFPs). The FFP configuration may indicate a periodicity of radio frames (e.g., a length of FFPs), and the UE 115-a may contend for access to the shared channel at the boundary of these FFPs. In an example, the UE 115-a (UE0) may be configured to communicate during FFPs 420, and the UE 115-b (UE1) may be configured to communicate during FFPs 425. A length of the FFPs 420 and the FFPs 425 (e.g., the periodicities of radio frames configured for the UE 115-a and the UE 115-b) may be the same or may be different.

In some aspects, the wireless device 405 may transmit an indication of the FFP configuration 410 to the UE 115-a for sidelink communications in the shared channel.

If the wireless device 405 is a network entity 105, the network entity 105 may transmit the FFP configuration 410 to the UE 115-a in an RRC configuration. For instance, the network entity 105 may configure the UE 115-a with the FFP configuration 410 using RRC signaling (e.g., for a resource allocation mode 1 for sidelink communications). Because the network entity 105 may identify sidelink traffic at the UE 115-a (e.g., for transmission by the UE 115-a), and the network entity 105 may identify periodic traffic for sidelink transmission from the UE 115-a, the network entity may be able to provide a suitable FFP configuration 410 to the UE 115-a. That is, the network entity may determine the FFP configuration 410 for the UE 115-a based on the sidelink traffic at the UE 115-a (e.g., to maximize throughput). In an example, the FFP configuration 410 may be based on an amount of sidelink traffic at the UE 115-a, an average length of bursts of sidelink transmissions from the UE 115-a, etc.

If the wireless device 405 is a UE 115, the UE 115 may transmit the FFP configuration 410 to the UE 115-a in a PC-5 RRC configuration. The UE 115 may be connected to the UE 115-a via a PC-5 interface over which the UE 115 may transmit, and the UE 115-a may receive, the PC-5 RRC configuration. The UE 115 providing the FFP configuration 410 to the UE 115-a may be referred to as an anchor UE 115 and may provide control information to multiple UEs 115 (e.g., out-of-coverage UEs 115). For instance, the anchor UE 115 may provide FFP configurations to the multiple UEs 115 (e.g., including the UE 115-a). In some examples, the anchor UE 115 for the multiple UEs 115 may be preconfigured (e.g., a programmable logic controller (PLC)). In other examples, the anchor UE 115 for the multiple UEs 115 may be RRC configured. In yet other examples, the anchor UE 115 may be selected by the multiple UEs 115 (e.g., multiple users may form a group and may select the center node as the anchor UE 115).

In some cases, the anchor UE 115 may support efficient techniques to determine a suitable FFP configuration 410 to provide to the UE 115-a. For instance, the anchor UE 115 may receive an indication of ongoing traffic from the multiple UEs 115 connected to the anchor UE 115 (e.g., an indication of a traffic pattern at each of the multiple UEs 115), and the anchor UE 115 may determine the FFP configuration for each UE 115 based on the traffic pattern at the UE 115 (e.g., and the traffic patterns at other UEs 115). Additionally, or alternatively, the anchor UE 115 may receive information from a network entity 105 (e.g., related to the traffic pattern at each UE 115 of the multiple UEs 115), and the anchor UE 115 may determine the FFP configuration for each UE 115 based on the information received from the network entity 105 (e.g., for a resource allocation mode 1 for sidelink communications).

In other aspects, the FFP configuration may be preconfigured at the UE 115-a, or the UE 115-a may self-configure the FFP configuration (e.g., each UE 115 may configure its own FFP based on its own traffic).

Once the UE 115-a is able to identify a suitable FFP configuration, the UE 115-a may communicate with other UEs 115 (e.g., the UE 115-c) in accordance with the FFP configuration. For instance, the UE 115-a may perform a channel access procedure to gain access to a COT (e.g., within an FFP or spanning one or more FFPs), and the UE 115-a may transmit sidelink data 415 to the UE 115-c in the COT. In addition, the UE 115-a may support efficient techniques for contending for access to a shared channel at the boundary of FFPs indicated by an FFP configuration. If the UE 115-a has no sidelink data 415 to transmit at the beginning of an FFP, the UE 115-a may not initiate a channel access procedure (e.g., initiate an FFP or COT) to gain access to a shared channel during the FFP. Otherwise, if the UE 115-a has sidelink data 415 to transmit at the beginning of an FFP, and the UE 115-a is capable of sharing a COT with another UE 115, the UE 115-a may use the techniques described herein to determine whether to initiate a channel access procedure to occupy a shared channel during the FFP or to share a COT with another UE 115.

In some aspects, the UE 115-a may be configured to prioritize COT sharing. COT sharing may be given a higher priority than initializing a channel access procedure. For instance, if COT sharing is available, the UE 115-a may share a COT instead of initiating a channel access procedure. The UE 115-a may identify sidelink data 415 to transmit in a shared channel in a first FFP, and the UE 115-a may monitor the shared channel in a second FFP for a sidelink transmission from the UE 115-b. If the UE 115-a detects the sidelink transmission from the UE 115-b, the UE 115-a may share a COT with the UE 115-b. Otherwise, the UE 115-a may initiate a channel access procedure to gain access to the first FFP to transmit the sidelink data 415 (e.g., to the UE 115-c).

The first FFP may be an example of an FFP configured for sidelink communications in a shared channel at the UE 115-a (e.g., the FFP 420-a or the FFP 420-b). The second FFP may be an example of an FFP configured for sidelink communications in a shared channel at the UE 115-a (e.g., the FFP 420-a or the FFP 420-b) or an FFP configured for sidelink communications in the shared channel at the UE 115-b (e.g., the FFP 425-a, the FFP 425-b, or the FFP 425-c). In one example, if the first FFP corresponds to the FFP 420-a, the second FFP may correspond to the FFP 425-a, and the UE 115-a may monitor for the sidelink transmission from the UE 115-b in the FFP 425-a. In another example, if the first FFP corresponds to the FFP 420-b, the second FFP may correspond to the FFP 420-a, and the UE 115-a may monitor for the sidelink transmission from the UE 115-b in the FFP 420-a (e.g., in an idle period of the FFP 420-a).

In some examples, the UE 115-a may monitor the shared channel in the second FFP for sidelink traffic from the UE 115-b (e.g., the UE 115-a may monitor the FFP of the UE 115-b). If the UE 115-a detects the sidelink traffic, the UE 115-a may share a COT with the UE 115-b. Otherwise, the UE 115-a may initiate a channel access procedure to occupy the shared channel in the first FFP (e.g., the FFP of the UE 115-a). Because the UE 115-a may monitor the second FFP (e.g., the FFP of the UE 115-b), it may be appropriate for the UE 115-a to identify an FFP configuration (e.g., duration and starting point) of the UE 115-b. In some cases, during an initial connection between the UE 115-a and the UE 115-b, the UE 115-a and the UE 115-b may exchange FFP configuration information with each other. In other cases, the wireless device 405 may indicate the FFP configuration of the UE 115-b to the UE 115-a. The UE 115-a may then use the FFP configuration of the UE 115-b to monitor for sidelink traffic from the UE 115-b in the second FFP.

In addition, it may be appropriate for the UE 115-a to determine a UE 115 from which sidelink traffic is detected. For instance, after detecting sidelink traffic, it may be appropriate for the UE 115-a to determine whether a UE 115-b transmitted the sidelink traffic in its own FFP or if the UE 115-b shared a COT with another UE 115. Using the techniques described herein, the UE 115-b may add one bit to sidelink control information (SCI) (e.g., SCI-2) to indicate whether or not sidelink traffic from the UE 115-b is transmitted in its own FFP. The UE 115-b may transmit the SCI to reserve resources to transmit the sidelink traffic, and the UE 115-a may receive the SCI. If the UE 115-a detects sidelink traffic from the UE 115-b, and the UE 115-a determines from the SCI that the sidelink traffic is transmitted in an FFP of the UE 115-b, the UE 115-a may share a COT with the UE 115-b. Otherwise, if the UE 115-a detects the sidelink traffic from the UE 115-b, but the UE 115-a determines from the SCI that the UE 115-b is sharing a COT, the UE 115-a may avoid sharing the COT (e.g., since the UE 115-a may not have detected sidelink traffic from the UE 115 that initiated the COT).

In some examples, the UE 115-a may monitor the shared channel in the second FFP for COT sharing information from the UE 115-b (e.g., and other UEs 115). If the UE 115-a detects the COT sharing information, the UE 115-a may share a COT with the UE 115-b. Otherwise, the UE 115-a may initiate a channel access procedure to occupy the shared channel in the first FFP (e.g., the FFP of the UE 115-a).

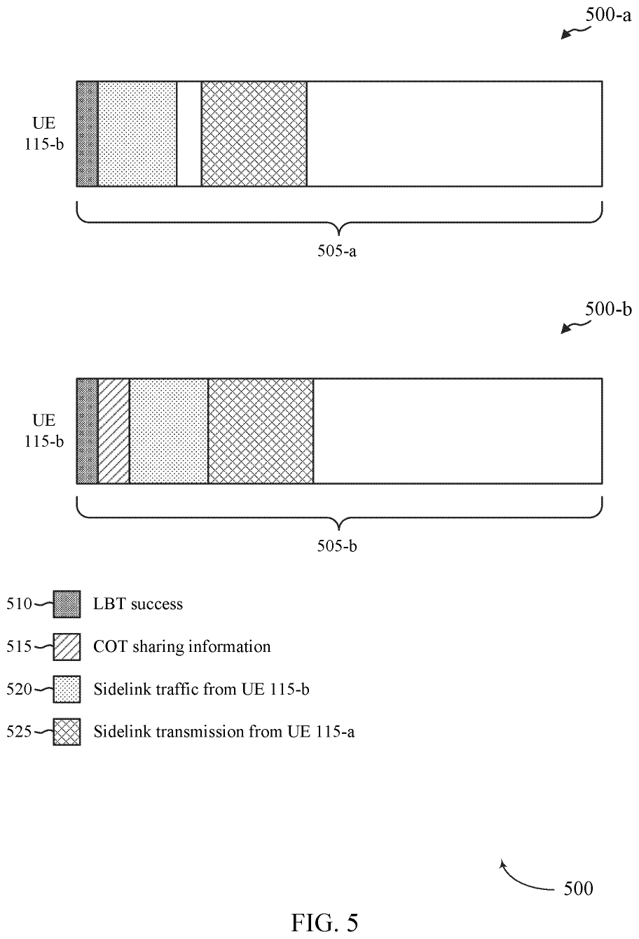

FIG. 5 illustrates an example of COT sharing 500 in accordance with one or more aspects of the present disclosure. In a first example 500-a, the UE 115-b may perform an LBT procedure 510 to gain access to a shared channel in a COT 505-a, and the LBT procedure 510 may succeed. Accordingly, the UE 115-b may transmit sidelink traffic 520 in the COT 505-a. The UE 115-a may detect the sidelink traffic 520 in the COT 505-a and may determine to share the COT 505-a with the UE 115-b based on detecting the sidelink traffic 520. Thus, the UE 115-a may transmit a sidelink transmission 525 in the COT 505-a. In a second example 500-b, the UE 115-b may perform an LBT procedure 510 to gain access to a shared channel in a COT 505-b, and the LBT procedure 510 may succeed. Accordingly, the UE 115-b may transmit sidelink traffic 520 in the COT 505-b. The UE 115-b may also transmit COT sharing information 515 in the COT 505-b. The UE 115-a may detect the COT sharing information 515 in the COT 505-b and may determine to share the COT 505-b with the UE 115-b based on detecting the COT sharing information 515. Thus, the UE 115-a may transmit a sidelink transmission 525 in the COT 505-b.

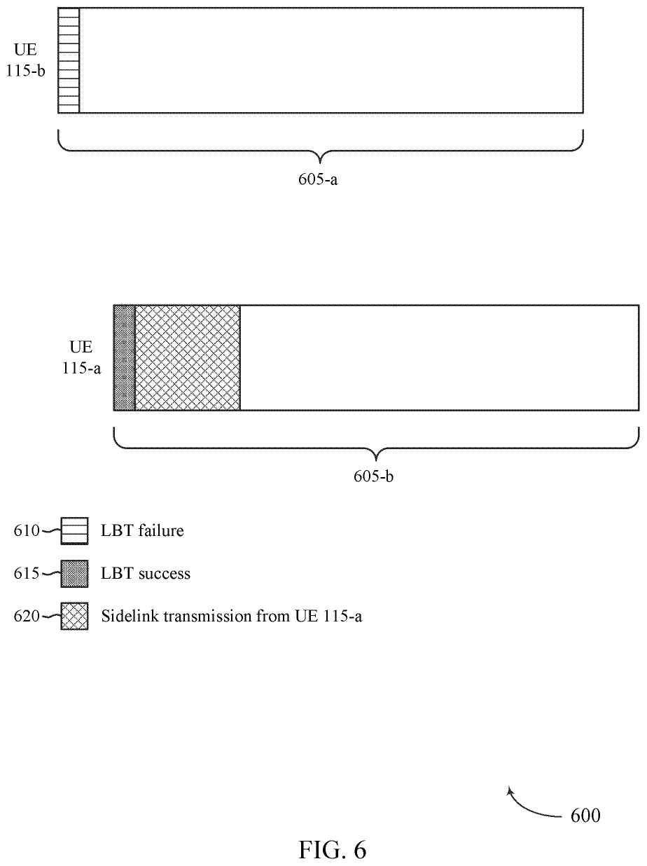

FIG. 6 illustrates an example of an initialization of a channel access procedure 600 in accordance with one or more aspects of the present disclosure. The UE 115-b may perform an LBT procedure 610 to gain access to a shared channel in a COT 605-a, but the LBT procedure 610 may fail. Because the LBT procedure 610 may fail, the UE 115-a may fail to detect a sidelink transmission (e.g., sidelink traffic or COT sharing information) from the UE 115-b. Thus, the UE 115-a may not be able to share a COT with the UE 115-b. Instead, the UE 115-a may perform an LBT procedure 615 to gain access to a shared channel in a COT 605-b, and the LBT procedure 615 may succeed. The UE 115-a may then transmit a sidelink transmission 620 in the COT 605-b.

In some aspects, the wireless device 405 (e.g., a network entity 105 or an anchor sidelink node) may dynamically control whether the UE 115-a may initiate a channel access procedure to occupy a shared channel in an FFP (e.g., starting at a boundary of the FFP). Because the wireless device 405 may be able to identify a traffic pattern of connected nodes, including the UE 115-a, the wireless device 405 may dynamically indicate which UEs 115 may initiate a channel access procedure to occupy a shared channel in an FFP based on a combined traffic pattern (e.g., at the UEs 115) to maximize resource utilization and reduce collision (e.g., as much as possible).

In some examples, the wireless device 405 may be a network entity 105, and the network entity 105 may indicate whether or not the UE 115-a is to initiate a channel access procedure to occupy a shared channel in an FFP (e.g., for a resource allocation mode 1). The network entity 105 may add a bit field (e.g., channel access field) to downlink control information (DCI) (e.g., DCI 3_0 or DCI 3_1) to inform sidelink devices, including the UE 115-a, of whether or not to initiate a channel access procedure in their own FFPs for sidelink transmissions. Table 3 shows an example of indications that may be included in DCI to indicate whether to initiate a channel access procedure.

TABLE 3
Indications included in DCI to indicate whether
to initiate a channel access procedure

| Bit field | Resource associated with |
|---|---|
| mapped to index | a sidelink transmission |
| 0 | Share COT with other UE |
| 1 | Initiate its own FFP |

In other examples, the wireless device 405 may be an anchor UE 115, and the anchor UE 115 may indicate whether or not the UE 115-a is to initiate a channel access procedure to occupy a shared channel in an FFP.

In one aspect, the anchor UE 115 may transmit a unicast transmission (e.g., in SCI-2) to the UE 115-a indicating whether the UE 115-a is to initiate a channel access procedure to occupy a shared channel in an FFP. In some cases, the unicast transmission may include a single bit indicating whether the UE 115-a is to initiate a channel access procedure to occupy a shared channel in a next upcoming FFP. A next upcoming FFP may refer to an FFP immediately following a time at which the unicast transmission is received at the UE 115-a (e.g., an FFP subsequent and adjacent to the FFP in which the unicast transmission is received). In other cases, the unicast transmission may include a time indicator indicating an FFP for which the UE 115-a may initiate a channel access procedure to occupy a shared channel. For instance, a time indicator of one may indicate that the UE 115-a may initiate a channel access procedure to occupy a shared channel in a next upcoming FFP, a time indicator of two may indicate that a UE 115 may initiate a channel access procedure to occupy a shared channel in an FFP immediately following the next upcoming FFP, etc.

In another aspect, the anchor UE 115 may transmit a groupcast transmission to multiple UEs 115 indicating whether each UE 115 of the multiple UEs 115 (e.g., including the UE 115-a) is to initiate a channel access procedure to occupy a shared channel in an FFP.

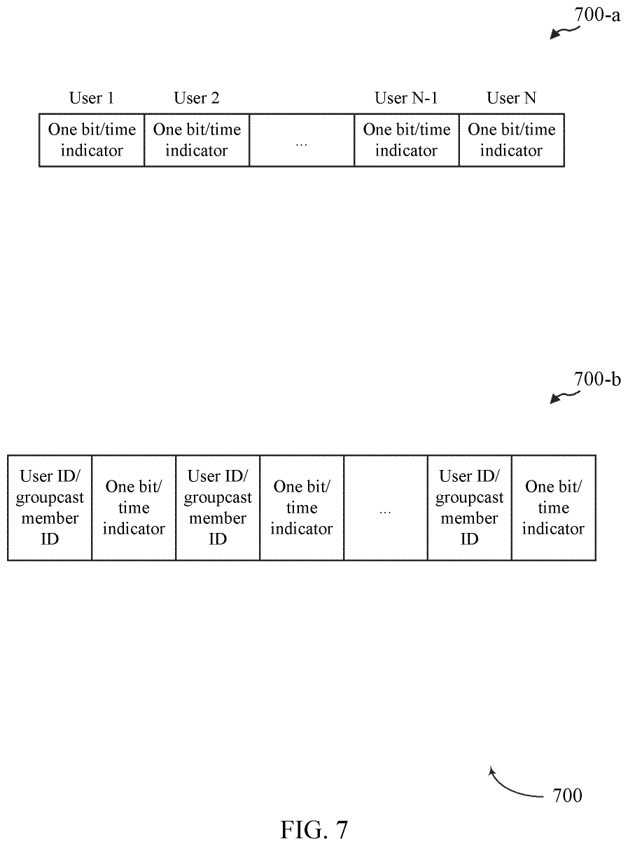

FIG. 7 illustrates an example of groupcast transmissions 700 indicating whether each UE 115 of multiple UEs 115 is to initiate a channel access procedure to occupy a shared channel in an FFP in accordance with one or more aspects of the present disclosure.

In a first example 700-a, an anchor UE 115 may add a bitmap to SCI (e.g., SCI-2) to indicate which UE 115 is to initiate a channel access procedure in an FFP. The addition of the bitmap may be suitable for a static deployment (e.g., where the quantity of UEs 115 connected to the anchor UE 115 is static). In some cases, each field in the bitmap may correspond to a UE 115 and may include a bit indicating whether the UE 115 is to initiate a channel access procedure to occupy a shared channel in a next upcoming FFP. A next upcoming FFP may refer to an FFP immediately following a time at which the bitmap is received (e.g., an FFP subsequent and adjacent to the FFP in which the bitmap is received). In other cases, each field in the bitmap may correspond to a UE 115 and may include a time indicator indicating an FFP for which the UE 115 may initiate a channel access procedure to occupy a shared channel.

In a second example 700-b, an anchor UE 115 may add a field to SCI (e.g., SCI-2) for each UE 115 of multiple UEs indicating whether the UE 115 is to initiate a channel access procedure in an FFP. The field for a UE 115 may include a user identifier (ID) (e.g., groupcast member ID) identifying the UE 115 and a bit or time indicator for the UE 115. As described, the bit may indicate whether the UE 115 is to initiate a channel access procedure to occupy a shared channel in a next upcoming FFP, and the timing indicator may indicate an FFP for which the UE 115 may initiate a channel access procedure to occupy a shared channel.

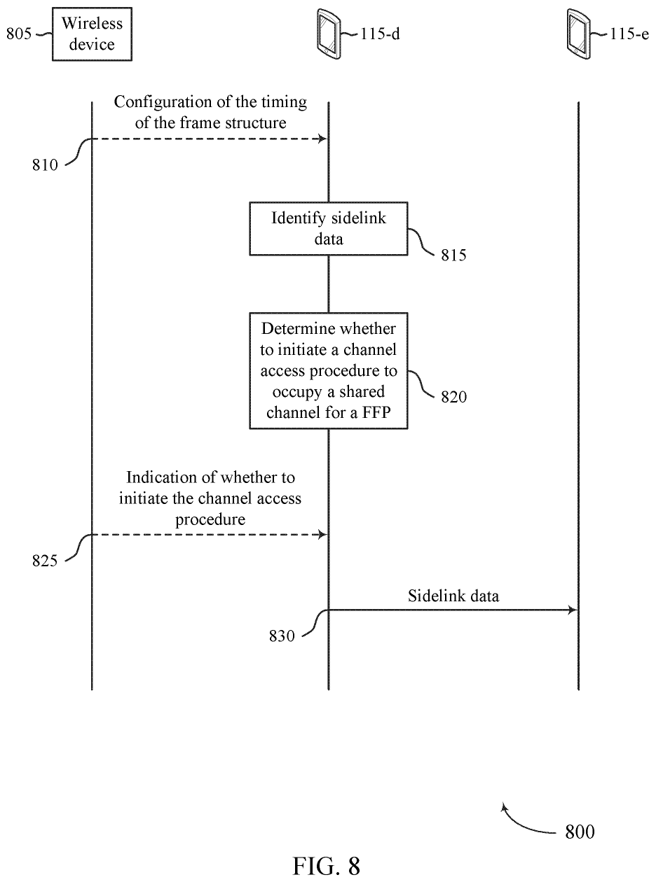

FIG. 8 illustrates an example of a process flow 800 that supports sidelink communication using fixed frame periods in accordance with one or more aspects of the present disclosure. The process flow 800 includes a wireless device 805, which may be an example of a network entity 105 or a UE 115 described with reference to FIGS. 1-7. The process flow 800 also includes a UE 115-d and a UE 115-e, which may be examples of UEs 115 described with reference to FIGS. 1-7. The process flow 800 may implement aspects of the wireless communications system 100. For instance, the process flow 800 may support efficient techniques for facilitating sidelink communications in a shared spectrum (e.g., in an FBE system).

In the following description of the process flow 800, the signaling exchanged between the wireless device 805, the UE 115-d, and the UE 115-e may be exchanged in a different order than the example order shown, or the operations performed by the wireless device 805, the UE 115-d, and the UE 115-e may be performed in different orders or at different times. Some operations may also be omitted from the process flow 800, and other operations may be added to the process flow 800.

The UE 115-d may identify a configuration of a timing of a frame structure for sidelink communications via a shared channel. The configuration of the timing of the frame structure for sidelink communications via the shared channel may be referred to as an FFP configuration. The frame structure may include multiple frame periods having fixed time durations (e.g., FFPs).

In some examples, at 810, the wireless device 805 may transmit, and the UE 115-d may receive, an indication of the configuration of the timing of the frame structure. The wireless device 805 may identify the timing of the frame structure for sidelink communications at the UE 115-d via the shared channel based on a traffic pattern at the UE 115-d. If the wireless device 805 is a network entity 105, the network entity 105 may determine the traffic pattern at the UE 115-d based on sidelink communication scheduled at the UE 115-d by the network entity 105. If the wireless device 805 is an anchor UE 115, the anchor UE 115 may receive an indication of the traffic pattern at the UE 115-d from a network entity 105 or from the UE 115-d. In some other examples, the configuration of the timing of the frame structure may be preconfigured at the UE 115-d. In yet other examples, the UE 115-d may identify the configuration of the timing of the frame structure based on a traffic pattern at the UE 115-d.

At 815, the UE 115-d may identify sidelink data to transmit in a first frame period (e.g., first FFP) of multiple frame periods having fixed frame durations. The multiple frame periods may be established for communication by the UE 115-d via a shared channel (e.g., established in the FFP configuration). At 820, the UE 115-d may determine whether to initiate a channel access procedure to occupy the shared channel for first frame period.

In one aspect, the UE 115-d may monitor the shared channel during a second frame period (e.g., second FFP) of the multiple frame periods for a sidelink transmission from another UE 115, and the UE 115-d may determine whether to initiate the channel access procedure to occupy the shared channel during the first frame period based on the monitoring. The sidelink transmission from the other UE 115 may be a data transmission (e.g., sidelink traffic) or a sharing information transmission. In some cases, the UE 115-d may receive an indication of a configuration of the second frame period, and the UE 115-d may identify a starting boundary of the second frame period based on receiving the indication of the configuration of the second frame period. As such, the UE 115-d may be able to monitor for the sidelink transmission from the other UE 115 based on identifying the starting boundary of the second frame period.

If the UE 115-d detects the sidelink transmission, the UE 115-d may determine to share a COT initiated by the other UE 115 including the second frame period, and the UE 115-d may refrain from initiating the channel access procedure to occupy the shared channel during the first frame period. In some cases, the sidelink transmission may include an indication that the sidelink transmission is from the other UE 115. If the UE 115-d fails to detect the sidelink transmission, the UE 115-d may determine to initiate the channel access procedure to occupy the shared channel during the first frame period.

In another aspect, at 825, the wireless device 805 may transmit, and the UE 115-d may receive, an indication of whether to initiate the channel access procedure to occupy the shared channel during the first frame period or share a channel occupancy time initiated by another UE 115. The wireless device 805 may identify a traffic pattern of the UE 115-d, and the wireless device 805 may determine whether the UE 115-d is to initiate the channel access procedure to occupy the shared channel during the first frame period based on the traffic pattern of the UE 115-d. If the wireless device 805 is a network entity 105, the network entity 105 may identify the traffic pattern of the UE 115-d based on sidelink communications scheduled at the UE 115-d by the network entity 105. If the wireless device is a UE 115, the UE 115 may receive an indication of the traffic pattern at the UE 115-d from the UE 115-d or from a network entity 105.

Further, if the wireless device 805 is a network entity 105, the network entity 105 may transmit, and the UE 115-d may receive, DCI indicating whether to initiate the channel access procedure. If the wireless device 805 is a UE 115, the UE 115 may transmit, and the UE 115-d may receive, a groupcast transmission or unicast transmission indicating whether to initiate the channel access procedure. In some examples, the groupcast transmission may include a bitmap, and a bit or time indicator in the bitmap for the UE 115-d may indicate whether the UE 115-d is to initiate the channel access procedure to occupy the shared channel during the first frame period or share the COT initiated by the other UE 115. In some examples, the groupcast transmission may include a field with an identifier of the UE 115-d and an indication of whether the UE 115-d is to initiate the channel access procedure to occupy the shared channel during the first frame period or share the COT initiated by the other UE 115.

At 830, the UE 115-d may transmit sidelink data to the UE 115-e based on determining whether to initiate the channel access procedure to occupy the shared channel for the first frame period. For instance, if the UE 115-e determines to initiate the channel access procedure to occupy the shared channel for the first frame period, the UE 115-e may transmit the sidelink data in the first frame period if the channel access procedure is successful. If the channel access procedure is unsuccessful, the UE 115-d may contend for access to the shared channel at a later time, and the UE 115-d may transmit the sidelink data in a subsequent or future frame period. Alternatively, if the UE 115-e determines to share a COT initiated by another UE 115, the UE 115-e may transmit the sidelink data in the COT shared with the other UE 115.

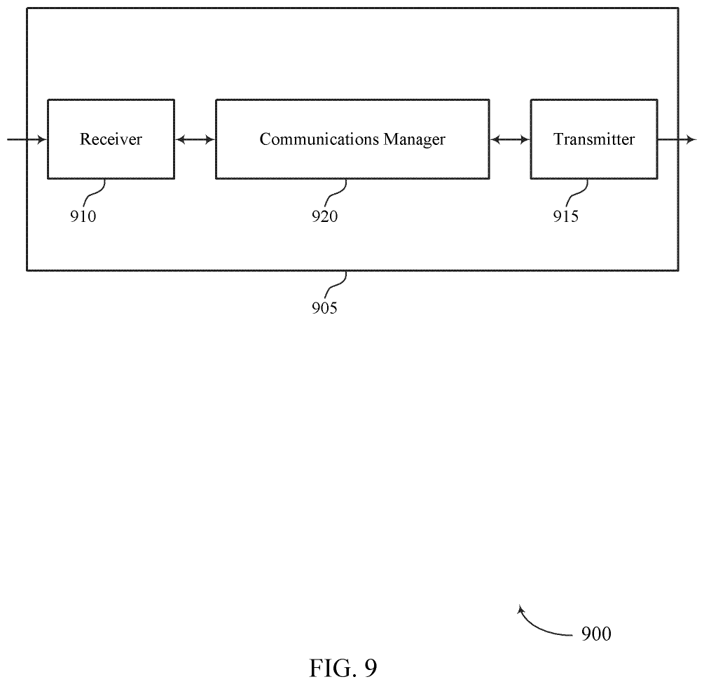

FIG. 9 shows a block diagram 900 of a device 905 that supports sidelink communication using fixed frame periods in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to sidelink communication using fixed frame periods). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to sidelink communication using fixed frame periods). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of sidelink communication using fixed frame periods as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first UE in accordance with examples as disclosed herein. For example, the communications manager 920 may be configured as or otherwise support a means for identifying sidelink data to transmit in a first frame period of a set of multiple frame periods having fixed frame durations established for communication by the first UE via a shared channel. The communications manager 920 may be configured as or otherwise support a means for determining whether to initiate a channel access procedure to occupy the shared channel for the first frame period. The communications manager 920 may be configured as or otherwise support a means for transmitting the sidelink data based on the determining.

Additionally, or alternatively, the communications manager 920 may support wireless communication at a wireless device in accordance with examples as disclosed herein. For example, the communications manager 920 may be configured as or otherwise support a means for identifying respective traffic patterns associated with a plurality of UEs. The communications manager 920 may be configured as or otherwise support a means for determining, based on the respective traffic patterns associated with the plurality of UEs, whether each UE of the plurality of UEs is to initiate a channel access procedure to occupy a shared channel during a first frame period of a set of multiple frame periods having fixed frame durations established for communication with the plurality of UEs. The communications manager 920 may be configured as or otherwise support a means for transmitting, to each UE, an indication of whether to initiate the channel access procedure to occupy the shared channel during the first frame period based on the determining.

Additionally, or alternatively, the communications manager 920 may support wireless communication at a first UE in accordance with examples as disclosed herein. For example, the communications manager 920 may be configured as or otherwise support a means for identifying, at the first UE, a configuration of a timing of a frame structure for sidelink communication via a shared channel, where the frame structure includes a set of multiple frame periods having a fixed frame duration. The communications manager 920 may be configured as or otherwise support a means for communicating during one or more of the set of multiple frame periods of the frame structure in accordance with the configuration.

Additionally, or alternatively, the communications manager 920 may support wireless communication at a wireless device in accordance with examples as disclosed herein. For example, the communications manager 920 may be configured as or otherwise support a means for identifying, based on a traffic pattern associated with a first UE, a timing of a frame structure for sidelink communication at the first UE via a shared channel, where the frame structure includes a set of multiple frame periods having a fixed frame duration. The communications manager 920 may be configured as or otherwise support a means for transmitting, to the first UE, an indication of a configuration of the timing of the frame structure.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing and reduced power consumption. In particular, because the device 905 may prioritize COT sharing or may be configured with whether to initiate a channel access procedure or share a COT, the device 905 may more efficiently contend for access to a shared channel and may avoid performing channel access procedures unnecessarily. As a result, less time and processing resources at the device 905 may be wasted on channel access procedures, and the device 905 may achieve the reduced processing and reduced power consumption.

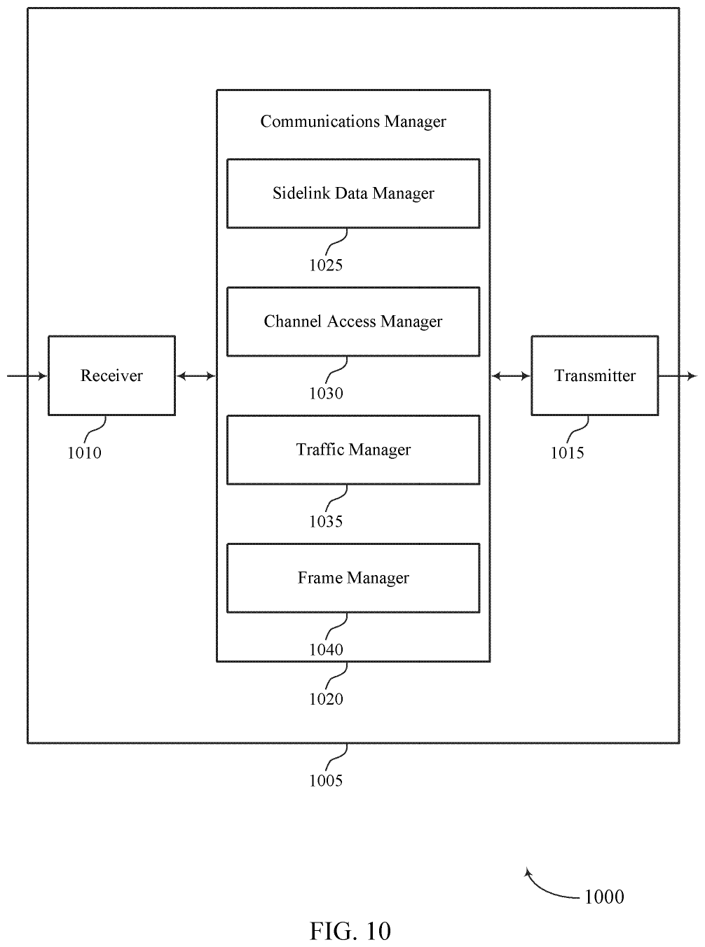

FIG. 10 shows a block diagram 1000 of a device 1005 that supports sidelink communication using fixed frame periods in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to sidelink communication using fixed frame periods). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to sidelink communication using fixed frame periods). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of sidelink communication using fixed frame periods as described herein. For example, the communications manager 1020 may include a sidelink data manager 1025, a channel access manager 1030, a traffic manager 1035, a frame manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first UE in accordance with examples as disclosed herein. The sidelink data manager 1025 may be configured as or otherwise support a means for identifying sidelink data to transmit in a first frame period of a set of multiple frame periods having fixed frame durations established for communication by the first UE via a shared channel. The channel access manager 1030 may be configured as or otherwise support a means for determining whether to initiate a channel access procedure to occupy the shared channel for the first frame period. The sidelink data manager 1025 may be configured as or otherwise support a means for transmitting the sidelink data based on the determining.

Additionally, or alternatively, the communications manager 1020 may support wireless communication at a wireless device in accordance with examples as disclosed herein. The traffic manager 1035 may be configured as or otherwise support a means for identifying respective traffic patterns associated with a plurality of UEs. The channel access manager 1030 may be configured as or otherwise support a means for determining, based on the respective traffic patterns associated with the plurality of UEs, whether each UE of the plurality of UEs is to initiate a channel access procedure to occupy a shared channel during a first frame period of a set of multiple frame periods having fixed frame durations established for communication with the set of multiple UEs. The channel access manager 1030 may be configured as or otherwise support a means for transmitting, to each UE, an indication of whether to initiate the channel access procedure to occupy the shared channel during the first frame period based on the determining.

Additionally, or alternatively, the communications manager 1020 may support wireless communication at a first UE in accordance with examples as disclosed herein. The frame manager 1040 may be configured as or otherwise support a means for identifying, at the first UE, a configuration of a timing of a frame structure for sidelink communication via a shared channel, where the frame structure includes a set of multiple frame periods having a fixed frame duration. The sidelink data manager 1025 may be configured as or otherwise support a means for communicating during one or more of the set of multiple frame periods of the frame structure in accordance with the configuration.

Additionally, or alternatively, the communications manager 1020 may support wireless communication at a wireless device in accordance with examples as disclosed herein. The frame manager 1040 may be configured as or otherwise support a means for identifying, based on a traffic pattern associated with a first UE, a timing of a frame structure for sidelink communication at the first UE via a shared channel, where the frame structure includes a set of multiple frame periods having a fixed frame duration. The frame manager 1040 may be configured as or otherwise support a means for transmitting, to the first UE, an indication of a configuration of the timing of the frame structure.

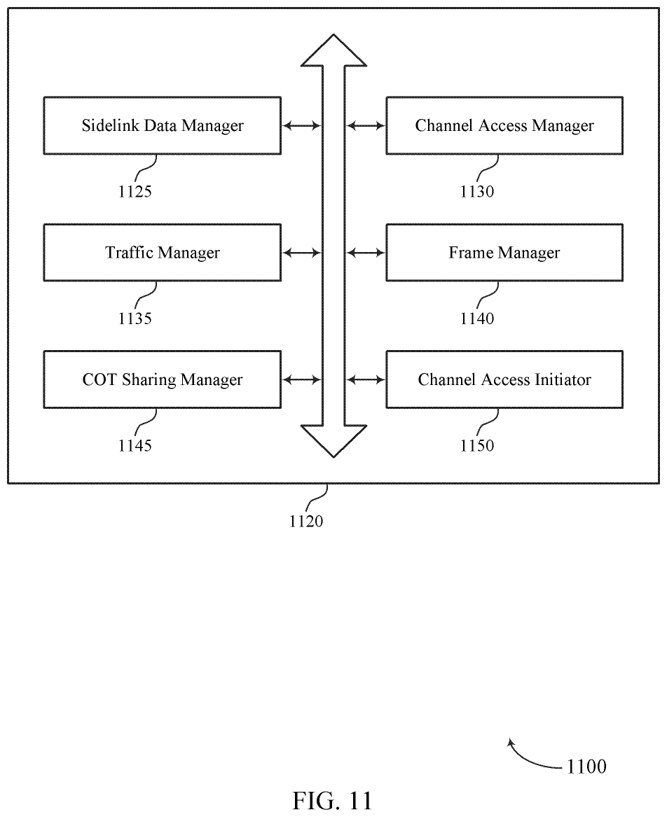

FIG. 11 shows a block diagram 1100 of a communications manager 1120 that supports sidelink communication using fixed frame periods in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of sidelink communication using fixed frame periods as described herein. For example, the communications manager 1120 may include a sidelink data manager 1125, a channel access manager 1130, a traffic manager 1135, a frame manager 1140, a COT sharing manager 1145, a channel access initiator 1150, or any combination thereof. Each of these components may communicate, directly or indirectly, with one another (e.g., via one or more buses).

The communications manager 1120 may support wireless communication at a first UE in accordance with examples as disclosed herein. The sidelink data manager 1125 may be configured as or otherwise support a means for identifying sidelink data to transmit in a first frame period of a set of multiple frame periods having fixed frame durations established for communication by the first UE via a shared channel. The channel access manager 1130 may be configured as or otherwise support a means for determining whether to initiate a channel access procedure to occupy the shared channel for the first frame period. In some examples, the sidelink data manager 1125 may be configured as or otherwise support a means for transmitting the sidelink data based on the determining.

In some examples, the COT sharing manager 1145 may be configured as or otherwise support a means for monitoring the shared channel during a second frame period of the set of multiple frame periods for a sidelink transmission from a second UE, where determining whether to initiate the channel access procedure to occupy the shared channel during the first frame period is based on the monitoring.

In some examples, to support determining whether to initiate the channel access procedure to occupy the shared channel during the first frame period, the COT sharing manager 1145 may be configured as or otherwise support a means for detecting the sidelink transmission from the second UE based on the monitoring. In some examples, to support determining whether to initiate the channel access procedure to occupy the shared channel during the first frame period, the COT sharing manager 1145 may be configured as or otherwise support a means for determining to share a channel occupancy time initiated by the second UE including the second frame period based on detecting the sidelink transmission. In some examples, to support determining whether to initiate the channel access procedure to occupy the shared channel during the first frame period, the channel access initiator 1150 may be configured as or otherwise support a means for refraining from initiating the channel access procedure to occupy the shared channel during the first frame period based on determining to share the channel occupancy time initiated by the second UE.

In some examples, the COT sharing manager 1145 may be configured as or otherwise support a means for receiving, in the sidelink transmission, an indication that the sidelink transmission is from the second UE, where detecting the sidelink transmission from the second UE is based on receiving the indication.

In some examples, to support determining whether to initiate the channel access procedure to occupy the shared channel during the first frame period, the channel access initiator 1150 may be configured as or otherwise support a means for determining to initiate the channel access procedure to occupy the shared channel during the first frame period based on failing to detect the sidelink transmission from the second UE.

In some examples, the frame manager 1140 may be configured as or otherwise support a means for receiving, from a network entity, the second UE, or a third UE, an indication of a configuration of the second frame period. In some examples, the frame manager 1140 may be configured as or otherwise support a means for identifying a starting boundary of the second frame period based on receiving the indication of the configuration of the second frame period, where the monitoring for the sidelink transmission from the second UE is based on identifying the starting boundary of the second frame period.

In some examples, the sidelink transmission from the second UE includes a data transmission or a sharing information transmission.

In some examples, the channel access manager 1130 may be configured as or otherwise support a means for receiving, in downlink control information from a network entity, an indication of whether to initiate the channel access procedure to occupy the shared channel during the first frame period or share a channel occupancy time initiated by a second UE.

In some examples, the channel access manager 1130 may be configured as or otherwise support a means for receiving, in a groupcast transmission from a second UE, an indication of whether to initiate the channel access procedure to occupy the shared channel during the first frame period or share a channel occupancy time initiated by a third UE.

In some examples, the groupcast transmission includes a bitmap, and a bit or time indicator in the bitmap for the first UE indicates whether the first UE is to initiate the channel access procedure to occupy the shared channel during the first frame period or share the channel occupancy time initiated by the third UE.

In some examples, the groupcast transmission includes a field including an identifier of the first UE and an indication of whether the first UE is to initiate the channel access procedure to occupy the shared channel during the first frame period or share the channel occupancy time initiated by the third UE.

In some examples, the channel access manager 1130 may be configured as or otherwise support a means for receiving, in a unicast transmission from a second UE, an indication of whether to initiate the channel access procedure to occupy the shared channel during the first frame period or share a channel occupancy time initiated by the second UE.

Additionally, or alternatively, the communications manager 1120 may support wireless communication at a wireless device in accordance with examples as disclosed herein. The traffic manager 1135 may be configured as or otherwise support a means for identifying respective traffic patterns associated with a plurality of UEs. In some examples, the channel access manager 1130 may be configured as or otherwise support a means for determining, based on the respective traffic patterns associated with the plurality of UEs, whether each UE of the plurality of UEs is to initiate a channel access procedure to occupy a shared channel during a first frame period of a set of multiple frame periods having fixed frame durations established for communication with the plurality of UEs. In some examples, the channel access manager 1130 may be configured as or otherwise support a means for transmitting, to each UE, an indication of whether to initiate the channel access procedure to occupy the shared channel during the first frame period based on the determining.

In some examples, to support transmitting the indication of whether to initiate the channel access procedure to occupy the shared channel during the first frame period, the channel access manager 1130 may be configured as or otherwise support a means for transmitting, in downlink control information, the indication of whether to initiate the channel access procedure to occupy the shared channel during the first frame period or share a channel occupancy time initiated by another UE.

In some examples, to support transmitting the indication of whether to initiate the channel access procedure to occupy the shared channel during the first frame period, the channel access manager 1130 may be configured as or otherwise support a means for transmitting, in a groupcast transmission, an indication of whether to initiate the channel access procedure to occupy the shared channel during the first frame period or share a channel occupancy time initiated by another UE.

In some examples, the groupcast transmission includes a bitmap, and each bit in the bitmap indicates whether a corresponding UE is to initiate the channel access procedure to occupy the shared channel during the first frame period or share a channel occupancy time initiated by another UE.

In some examples, the groupcast transmission includes a bitmap, and a time indicator in the bitmap indicates whether a corresponding UE is to initiate the channel access procedure to occupy the shared channel during each of one or more frame periods including the first frame period or share channel occupancy times initiated by other UEs.

In some examples, the groupcast transmission includes a field including an identifier of each UE and an indication of whether the each UE is to initiate the channel access procedure to occupy the shared channel during the first frame period or share a channel occupancy time with another UE.

In some examples, to support transmitting the indication of whether to initiate the channel access procedure to occupy the shared channel during the first frame period, the channel access manager 1130 may be configured as or otherwise support a means for transmitting, to each UE in a unicast transmission, an indication of whether to initiate the channel access procedure to occupy the shared channel during the first frame period or share a channel occupancy time initiated by another UE.

Additionally, or alternatively, the communications manager 1120 may support wireless communication at a first UE in accordance with examples as disclosed herein. The frame manager 1140 may be configured as or otherwise support a means for identifying, at the first UE, a configuration of a timing of a frame structure for sidelink communication via a shared channel, where the frame structure includes a set of multiple frame periods having a fixed frame duration. In some examples, the sidelink data manager 1125 may be configured as or otherwise support a means for communicating during one or more of the set of multiple frame periods of the frame structure in accordance with the configuration.

In some examples, to support identifying the configuration of the timing of the frame structure, the frame manager 1140 may be configured as or otherwise support a means for receiving, from a network entity or a second UE, an indication of the configuration of the timing of the frame structure.

In some examples, the configuration of the timing of the frame structure is preconfigured at the first UE.

In some examples, the frame manager 1140 may be configured as or otherwise support a means for identifying the configuration of the timing of the frame structure based on a traffic pattern at the first UE.

Additionally, or alternatively, the communications manager 1120 may support wireless communication at a wireless device in accordance with examples as disclosed herein. In some examples, the frame manager 1140 may be configured as or otherwise support a means for identifying, based on a traffic pattern associated with a first UE, a timing of a frame structure for sidelink communication at the first UE via a shared channel, where the frame structure includes a set of multiple frame periods having a fixed frame duration. In some examples, the frame manager 1140 may be configured as or otherwise support a means for transmitting, to the first UE, an indication of a configuration of the timing of the frame structure.

In some examples, the wireless device includes a network entity, and the traffic manager 1135 may be configured as or otherwise support a means for determining the traffic pattern associated with the first UE based on sidelink communication scheduled at the first UE by the network entity.

In some examples, the wireless device includes a second UE, and the traffic manager 1135 may be configured as or otherwise support a means for receiving, from a network entity or from the first UE, an indication of the traffic pattern at the first UE.

In some examples, the wireless device includes a second UE, and the second UE includes an anchor UE that is preconfigured, configured via signaling from a network entity, or selected by one or more UEs including the first UE.

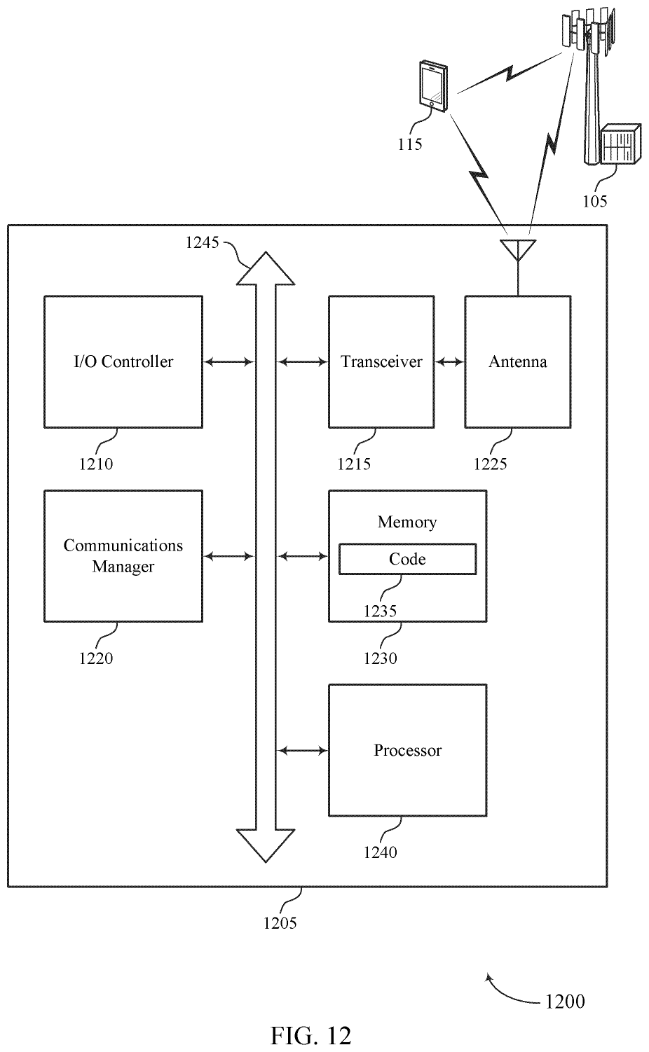

FIG. 12 shows a diagram of a system 1200 including a device 1205 that supports sidelink communication using fixed frame periods in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting sidelink communication using fixed frame periods). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a first UE in accordance with examples as disclosed herein. For example, the communications manager 1220 may be configured as or otherwise support a means for identifying sidelink data to transmit in a first frame period of a set of multiple frame periods having fixed frame durations established for communication by the first UE via a shared channel. The communications manager 1220 may be configured as or otherwise support a means for determining whether to initiate a channel access procedure to occupy the shared channel for the first frame period. The communications manager 1220 may be configured as or otherwise support a means for transmitting the sidelink data based on the determining.

Additionally, or alternatively, the communications manager 1220 may support wireless communication at a wireless device in accordance with examples as disclosed herein. For example, the communications manager 1220 may be configured as or otherwise support a means for identifying respective traffic patterns associated with a plurality of UEs. The communications manager 1220 may be configured as or otherwise support a means for determining, based on the respective traffic patterns associated with the plurality of UEs, whether each UE of the plurality of UEs is to initiate a channel access procedure to occupy a shared channel during a first frame period of a set of multiple frame periods having fixed frame durations established for communication with the plurality of UEs. The communications manager 1220 may be configured as or otherwise support a means for transmitting, to each UE, an indication of whether to initiate the channel access procedure to occupy the shared channel during the first frame period based on the determining.

Additionally, or alternatively, the communications manager 1220 may support wireless communication at a first UE in accordance with examples as disclosed herein. For example, the communications manager 1220 may be configured as or otherwise support a means for identifying, at the first UE, a configuration of a timing of a frame structure for sidelink communication via a shared channel, where the frame structure includes a set of multiple frame periods having a fixed frame duration. The communications manager 1220 may be configured as or otherwise support a means for communicating during one or more of the set of multiple frame periods of the frame structure in accordance with the configuration.

Additionally, or alternatively, the communications manager 1220 may support wireless communication at a wireless device in accordance with examples as disclosed herein. For example, the communications manager 1220 may be configured as or otherwise support a means for identifying, based on a traffic pattern associated with a first UE, a timing of a frame structure for sidelink communication at the first UE via a shared channel, where the frame structure includes a set of multiple frame periods having a fixed frame duration. The communications manager 1220 may be configured as or otherwise support a means for transmitting, to the first UE, an indication of a configuration of the timing of the frame structure.

By including or configuring the communications manager 1220 in accordance with examples as described herein, the device 1205 may support techniques for reduced processing and reduced power consumption. In particular, because the device 1205 may prioritize COT sharing or may be configured with whether to initiate a channel access procedure or share a COT, the device 1205 may more efficiently contend for access to a shared channel and may avoid performing channel access procedures unnecessarily. As a result, less time and processing resources at the device 905 may be wasted on channel access procedures, and the device 1205 may achieve the reduced processing and reduced power consumption.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of sidelink communication using fixed frame periods as described herein, or the processor 1240 and the memory 1230 may be otherwise configured to perform or support such operations.

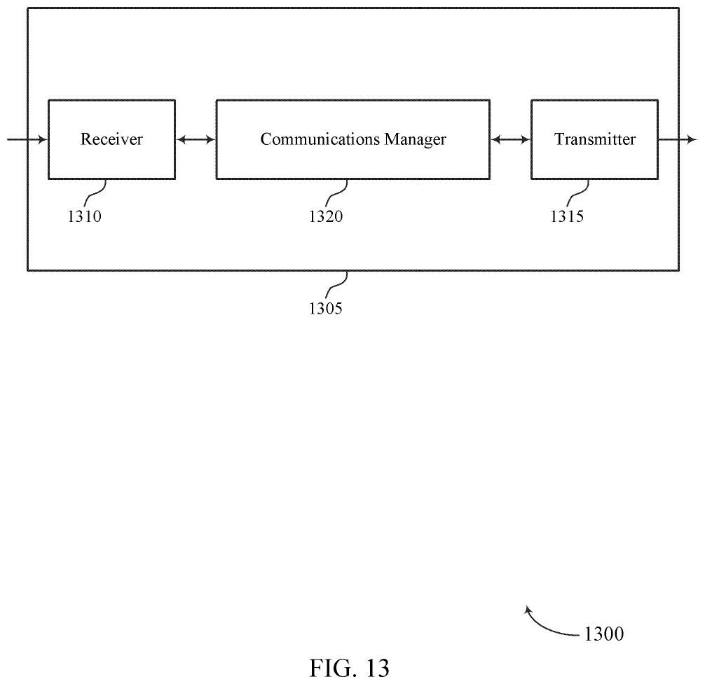

FIG. 13 shows a block diagram 1300 of a device 1305 that supports sidelink communication using fixed frame periods in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of sidelink communication using fixed frame periods as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a wireless device in accordance with examples as disclosed herein. For example, the communications manager 1320 may be configured as or otherwise support a means for identifying respective traffic patterns associated with a plurality of UEs. The communications manager 1320 may be configured as or otherwise support a means for determining, based on the respective traffic patterns associated with the plurality of UEs, whether each UE of the plurality of UEs is to initiate a channel access procedure to occupy a shared channel during a first frame period of a set of multiple frame periods having fixed frame durations established for communication with the plurality of UEs. The communications manager 1320 may be configured as or otherwise support a means for transmitting, to each UE, an indication of whether to initiate the channel access procedure to occupy the shared channel during the first frame period based on the determining.

Additionally, or alternatively, the communications manager 1320 may support wireless communication at a wireless device in accordance with examples as disclosed herein. For example, the communications manager 1320 may be configured as or otherwise support a means for identifying, based on a traffic pattern associated with a first UE, a timing of a frame structure for sidelink communication at the first UE via a shared channel, where the frame structure includes a set of multiple frame periods having a fixed frame duration. The communications manager 1320 may be configured as or otherwise support a means for transmitting, to the first UE, an indication of a configuration of the timing of the frame structure.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for more efficient utilization of communication resources. In particular, because the device 1305 may signal an FFP configuration to a UE and may configure a UE with whether to initiate a channel access procedure or share a COT, the device 1305 may improve the utilization of resources at the UE. As a result, the device 1305 may have access to more resources for communications with the UE or other UEs, and the device 1305 may achieve more efficient utilization of communication resources.

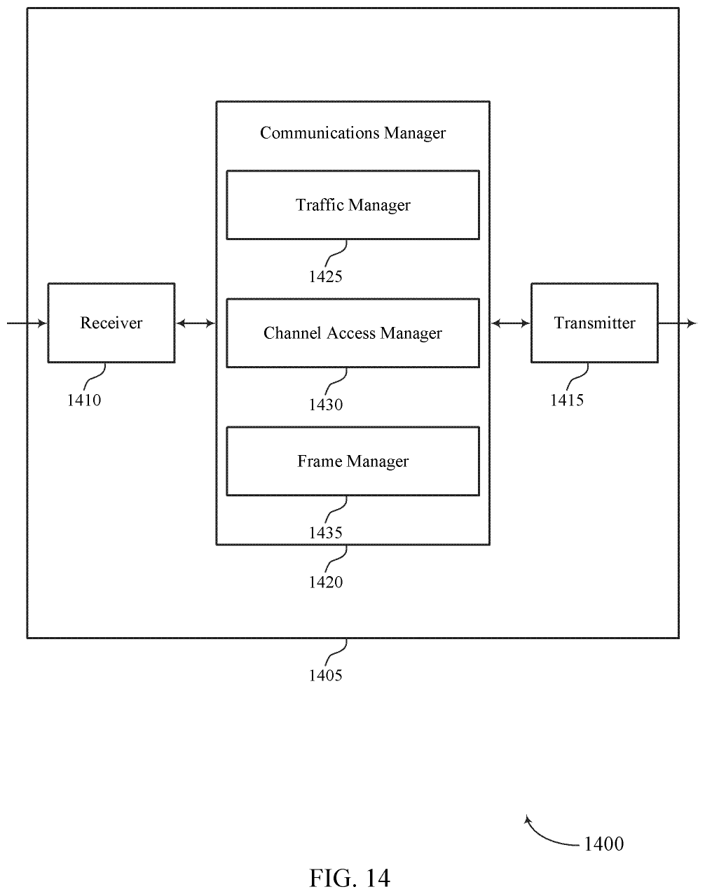

FIG. 14 shows a block diagram 1400 of a device 1405 that supports sidelink communication using fixed frame periods in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of sidelink communication using fixed frame periods as described herein. For example, the communications manager 1420 may include a traffic manager 1425, a channel access manager 1430, a frame manager 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a wireless device in accordance with examples as disclosed herein. The traffic manager 1425 may be configured as or otherwise support a means for identifying respective traffic patterns associated with a plurality of UEs. The channel access manager 1430 may be configured as or otherwise support a means for determining, based on the respective traffic patterns associated with the plurality of UEs, whether each UE of the plurality of UEs is to initiate a channel access procedure to occupy a shared channel during a first frame period of a set of multiple frame periods having fixed frame durations established for communication with the plurality of UEs. The channel access manager 1430 may be configured as or otherwise support a means for transmitting, to the each UE, an indication of whether to initiate the channel access procedure to occupy the shared channel during the first frame period based on the determining.

Additionally, or alternatively, the communications manager 1420 may support wireless communication at a wireless device in accordance with examples as disclosed herein. The frame manager 1435 may be configured as or otherwise support a means for identifying, based on a traffic pattern at a first UE, a timing of a frame structure for sidelink communication at the first UE via a shared channel, where the frame structure includes a set of multiple frame periods having a fixed frame duration. The frame manager 1435 may be configured as or otherwise support a means for transmitting, to the first UE, an indication of a configuration of the timing of the frame structure.

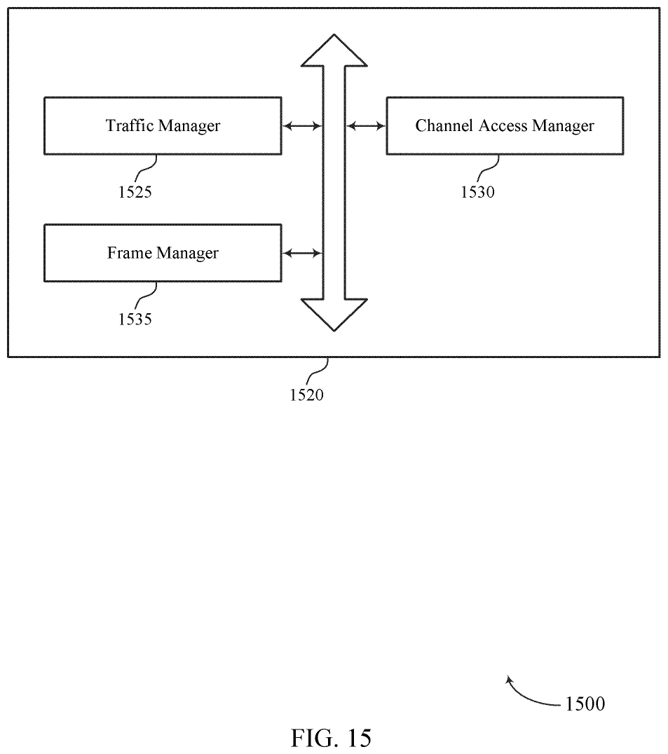

FIG. 15 shows a block diagram 1500 of a communications manager 1520 that supports sidelink communication using fixed frame periods in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of sidelink communication using fixed frame periods as described herein. For example, the communications manager 1520 may include a traffic manager 1525, a channel access manager 1530, a frame manager 1535, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communication at a wireless device in accordance with examples as disclosed herein. The traffic manager 1525 may be configured as or otherwise support a means for identifying respective traffic patterns associated with a plurality of UEs. The channel access manager 1530 may be configured as or otherwise support a means for determining, based on the respective traffic patterns associated with the plurality of UEs, whether each UE of the plurality of UEs is to initiate a channel access procedure to occupy a shared channel during a first frame period of a set of multiple frame periods having fixed frame durations established for communication with the plurality of UEs. In some examples, the channel access manager 1530 may be configured as or otherwise support a means for transmitting, to each UE, an indication of whether to initiate the channel access procedure to occupy the shared channel during the first frame period based on the determining.

In some examples, to support transmitting the indication of whether to initiate the channel access procedure to occupy the shared channel during the first frame period, the channel access manager 1530 may be configured as or otherwise support a means for transmitting, in downlink control information, the indication of whether to initiate the channel access procedure to occupy the shared channel during the first frame period or share a channel occupancy time initiated by another UE.

In some examples, to support transmitting the indication of whether to initiate the channel access procedure to occupy the shared channel during the first frame period, the channel access manager 1530 may be configured as or otherwise support a means for transmitting, in a groupcast transmission, an indication of whether to initiate the channel access procedure to occupy the shared channel during the first frame period or share a channel occupancy time initiated by another UE.

In some examples, the groupcast transmission includes a bitmap, and each bit in the bitmap indicates whether a corresponding UE is to initiate the channel access procedure to occupy the shared channel during the first frame period or share a channel occupancy time initiated by another UE.

In some examples, the groupcast transmission includes a bitmap, and a time indicator in the bitmap indicates whether a corresponding UE is to initiate the channel access procedure to occupy the shared channel during each of one or more frame periods including the first frame period or share channel occupancy times initiated by other UEs.

In some examples, the groupcast transmission includes a field including an identifier of each UE and an indication of whether the each UE is to initiate the channel access procedure to occupy the shared channel during the first frame period or share a channel occupancy time with another UE.

In some examples, to support transmitting the indication of whether to initiate the channel access procedure to occupy the shared channel during the first frame period, the channel access manager 1530 may be configured as or otherwise support a means for transmitting, to each UE in a unicast transmission, an indication of whether to initiate the channel access procedure to occupy the shared channel during the first frame period or share a channel occupancy time initiated by another UE.

Additionally, or alternatively, the communications manager 1520 may support wireless communication at a wireless device in accordance with examples as disclosed herein. The frame manager 1535 may be configured as or otherwise support a means for identifying, based on a traffic pattern associated with a first UE, a timing of a frame structure for sidelink communication at the first UE via a shared channel, where the frame structure includes a set of multiple frame periods having a fixed frame duration. In some examples, the frame manager 1535 may be configured as or otherwise support a means for transmitting, to the first UE, an indication of a configuration of the timing of the frame structure.

In some examples, the wireless device includes a network entity, and the traffic manager 1525 may be configured as or otherwise support a means for determining the traffic pattern at the first UE based on sidelink communication scheduled at the first UE by the network entity.

In some examples, the wireless device includes a second UE, and the traffic manager 1525 may be configured as or otherwise support a means for receiving, from a network entity or from the first UE, an indication of the traffic pattern at the first UE.

In some examples, the wireless device includes a second UE, and the second UE includes an anchor UE that is preconfigured, configured via signaling from a network entity, or selected by one or more UEs including the first UE.

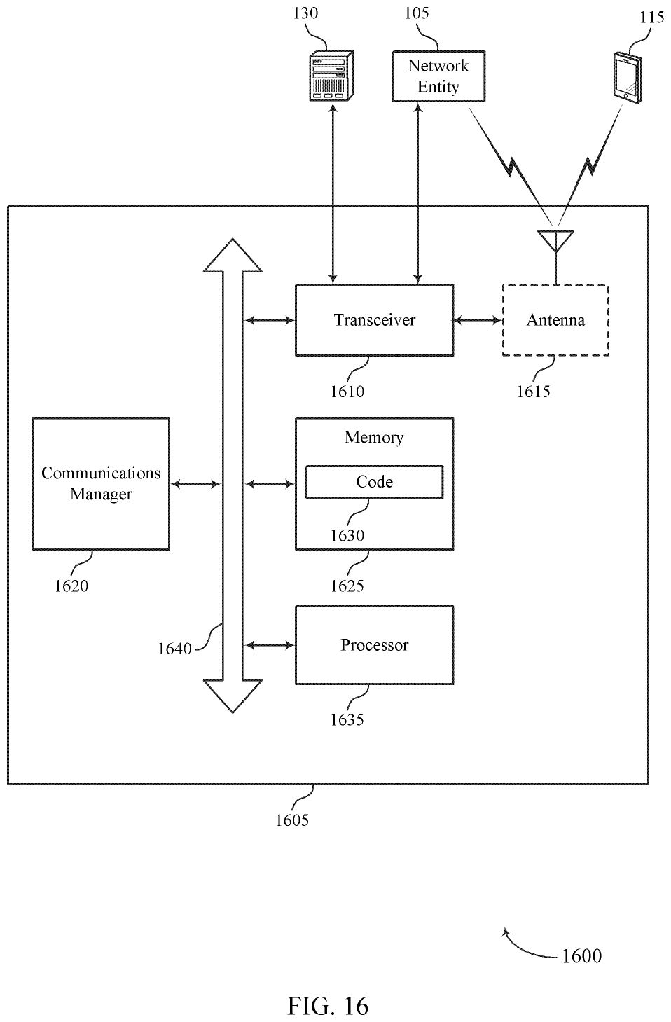

FIG. 16 shows a diagram of a system 1600 including a device 1605 that supports sidelink communication using fixed frame periods in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. The transceiver 1610, or the transceiver 1610 and one or more antennas 1615 or wired interfaces, where applicable, may be an example of a transmitter 1315, a transmitter 1415, a receiver 1310, a receiver 1410, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting sidelink communication using fixed frame periods). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communication at a wireless device in accordance with examples as disclosed herein. For example, the communications manager 1620 may be configured as or otherwise support a means for identifying respective traffic patterns associated with a plurality of UEs. The communications manager 1620 may be configured as or otherwise support a means for determining, based on the respective traffic patterns associated with the plurality of UEs, whether each UE of the plurality of UEs is to initiate a channel access procedure to occupy a shared channel during a first frame period of a set of multiple frame periods having fixed frame durations established for communication with the plurality of UEs. The communications manager 1620 may be configured as or otherwise support a means for transmitting, to the each UE, an indication of whether to initiate the channel access procedure to occupy the shared channel during the first frame period based on the determining.

Additionally, or alternatively, the communications manager 1620 may support wireless communication at a wireless device in accordance with examples as disclosed herein. For example, the communications manager 1620 may be configured as or otherwise support a means for identifying, based on a traffic pattern associated with a first UE, a timing of a frame structure for sidelink communication at the first UE via a shared channel, where the frame structure includes a set of multiple frame periods having a fixed frame duration. The communications manager 1620 may be configured as or otherwise support a means for transmitting, to the first UE, an indication of a configuration of the timing of the frame structure.

By including or configuring the communications manager 1620 in accordance with examples as described herein, the device 1605 may support techniques for more efficient utilization of communication resources. In particular, because the device 1605 may signal an FFP configuration to a UE and may configure a UE with whether to initiate a channel access procedure or share a COT, the device 1605 may improve the utilization of resources at the UE. As a result, the device 1605 may have access to more resources for communications with the UE or other UEs, and the device 1605 may achieve more efficient utilization of communication resources.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the processor 1635, the memory 1625, the code 1630, the transceiver 1610, or any combination thereof. For example, the code 1630 may include instructions executable by the processor 1635 to cause the device 1605 to perform various aspects of sidelink communication using fixed frame periods as described herein, or the processor 1635 and the memory 1625 may be otherwise configured to perform or support such operations.

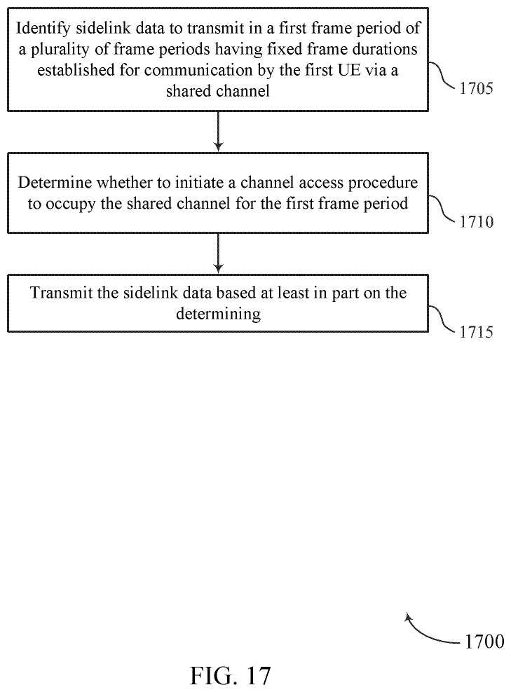

FIG. 17 shows a flowchart illustrating a method 1700 that supports sidelink communication using fixed frame periods in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include identifying sidelink data to transmit in a first frame period of a set of multiple frame periods having fixed frame durations established for communication by the first UE via a shared channel. The operations of 1705 may be performed in accordance with examples as disclosed herein. In some examples, aspects of the operations of 1705 may be performed by a sidelink data manager 1125 as described with reference to FIG. 11.

At 1710, the method may include determining whether to initiate a channel access procedure to occupy the shared channel for the first frame period. The operations of 1710 may be performed in accordance with examples as disclosed herein. In some examples, aspects of the operations of 1710 may be performed by a channel access manager 1130 as described with reference to FIG. 11.

At 1715, the method may include transmitting the sidelink data based on the determining. The operations of 1715 may be performed in accordance with examples as disclosed herein. In some examples, aspects of the operations of 1715 may be performed by a sidelink data manager 1125 as described with reference to FIG. 11.

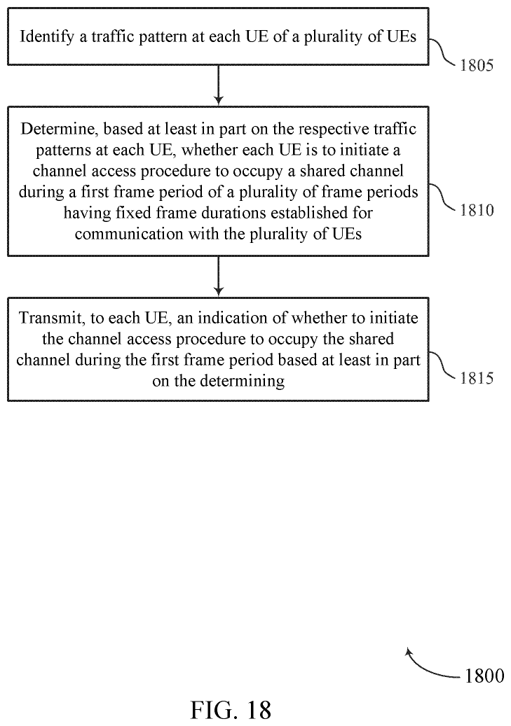

FIG. 18 shows a flowchart illustrating a method 1800 that supports sidelink communication using fixed frame periods in accordance with one or more aspects of the present disclosure. The operations of the method 1800 may be implemented by a UE or a network entity or its components as described herein. For example, the operations of the method 1800 may be performed by a UE 115 as described with reference to FIGS. 1 through 12 or a network entity as described with reference to FIGS. 1 through 8 and 13 through 16. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include identifying a traffic pattern at each UE of a set of multiple UEs. The operations of 1805 may be performed in accordance with examples as disclosed herein. In some examples, aspects of the operations of 1805 may be performed by a traffic manager 1135 or a traffic manager 1525 as described with reference to FIGS. 11 and 15.

At 1810, the method may include determining, based on the respective traffic patterns at each UE, whether each UE is to initiate a channel access procedure to occupy a shared channel during a first frame period of a set of multiple frame periods having fixed frame durations established for communication with the set of multiple UEs. The operations of 1810 may be performed in accordance with examples as disclosed herein. In some examples, aspects of the operations of 1810 may be performed by a channel access manager 1130 or a channel access manager 1530 as described with reference to FIGS. 11 and 15.

At 1815, the method may include transmitting, to each UE, an indication of whether to initiate the channel access procedure to occupy the shared channel during the first frame period based on the determining. The operations of 1815 may be performed in accordance with examples as disclosed herein. In some examples, aspects of the operations of 1815 may be performed by a channel access manager 1130 or a channel access manager 1530 as described with reference to FIGS. 11 and 15.

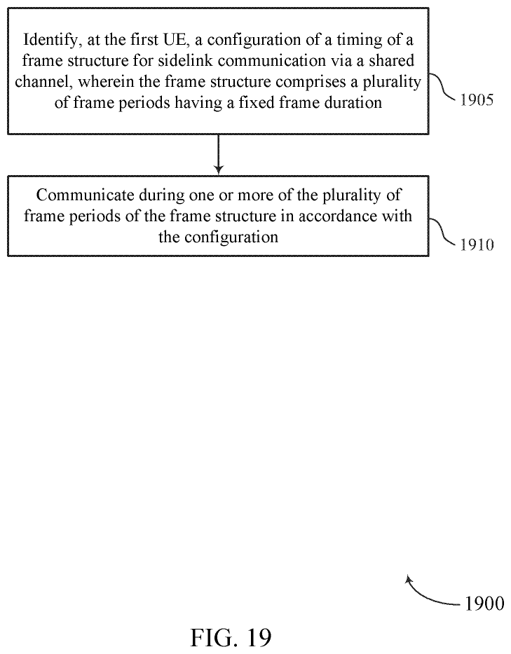

FIG. 19 shows a flowchart illustrating a method 1900 that supports sidelink communication using fixed frame periods in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include identifying, at the first UE, a configuration of a timing of a frame structure for sidelink communication via a shared channel, where the frame structure includes a set of multiple frame periods having a fixed frame duration. The operations of 1905 may be performed in accordance with examples as disclosed herein. In some examples, aspects of the operations of 1905 may be performed by a frame manager 1140 as described with reference to FIG. 11.

At 1910, the method may include communicating during one or more of the set of multiple frame periods of the frame structure in accordance with the configuration. The operations of 1910 may be performed in accordance with examples as disclosed herein. In some examples, aspects of the operations of 1910 may be performed by a sidelink data manager 1125 as described with reference to FIG. 11.

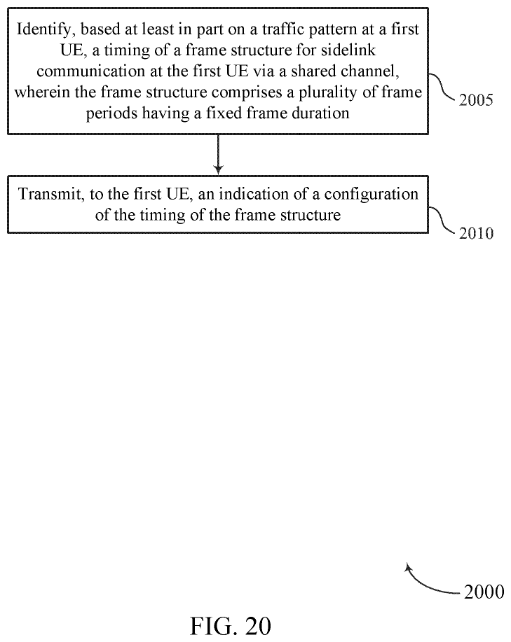

FIG. 20 shows a flowchart illustrating a method 2000 that supports sidelink communication using fixed frame periods in accordance with one or more aspects of the present disclosure. The operations of the method 2000 may be implemented by a UE or a network entity or its components as described herein. For example, the operations of the method 2000 may be performed by a UE 115 as described with reference to FIGS. 1 through 12 or a network entity as described with reference to FIGS. 1 through 8 and 13 through 16. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 2005, the method may include identifying, based on a traffic pattern at a first UE, a timing of a frame structure for sidelink communication at the first UE via a shared channel, where the frame structure includes a set of multiple frame periods having a fixed frame duration. The operations of 2005 may be performed in accordance with examples as disclosed herein. In some examples, aspects of the operations of 2005 may be performed by a frame manager 1140 or a frame manager 1535 as described with reference to FIGS. 11 and 15.

At 2010, the method may include transmitting, to the first UE, an indication of a configuration of the timing of the frame structure. The operations of 2010 may be performed in accordance with examples as disclosed herein. In some examples, aspects of the operations of 2010 may be performed by a frame manager 1140 or a frame manager 1535 as described with reference to FIGS. 11 and 15.

The following provides an overview of aspects of the present disclosure:

Aspect 1: A method for wireless communication at a first UE, comprising: identifying sidelink data to transmit in a first frame period of a plurality of frame periods having fixed frame durations established for communication by the first UE via a shared channel; determining whether to initiate a channel access procedure to occupy the shared channel for the first frame period; and transmitting the sidelink data based at least in part on the determining.

Aspect 2: The method of aspect 1, further comprising: monitoring the shared channel during a second frame period of the plurality of frame periods for a sidelink transmission from a second UE, wherein determining whether to initiate the channel access procedure to occupy the shared channel during the first frame period is based at least in part on the monitoring.

Aspect 3: The method of aspect 2, wherein determining whether to initiate the channel access procedure to occupy the shared channel during the first frame period comprises: detecting the sidelink transmission from the second UE based at least in part on the monitoring; determining to share a channel occupancy time initiated by the second UE comprising the second frame period based at least in part on detecting the sidelink transmission; and refraining from initiating the channel access procedure to occupy the shared channel during the first frame period based at least in part on determining to share the channel occupancy time initiated by the second UE.

Aspect 4: The method of aspect 3, further comprising: receiving, in the sidelink transmission, an indication that the sidelink transmission is from the second UE, wherein detecting the sidelink transmission from the second UE is based at least in part on receiving the indication.

Aspect 5: The method of any of aspects 2 through 4, wherein determining whether to initiate the channel access procedure to occupy the shared channel during the first frame period comprises: determining to initiate the channel access procedure to occupy the shared channel during the first frame period based at least in part on failing to detect the sidelink transmission from the second UE.

Aspect 6: The method of any of aspects 2 through 5, further comprising: receiving, from a network entity, the second UE, or a third UE, an indication of a configuration of the second frame period; and identifying a starting boundary of the second frame period based at least in part on receiving the indication of the configuration of the second frame period, wherein the monitoring for the sidelink transmission from the second UE is based at least in part on identifying the starting boundary of the second frame period.

Aspect 7: The method of any of aspects 2 through 6, wherein the sidelink transmission from the second UE comprises a data transmission or a sharing information transmission.

Aspect 8: The method of any of aspects 1 through 7, further comprising:

receiving, in downlink control information from a network entity, an indication of whether to initiate the channel access procedure to occupy the shared channel during the first frame period or share a channel occupancy time initiated by a second UE.

Aspect 9: The method of any of aspects 1 through 8, further comprising: receiving, in a groupcast transmission from a second UE, an indication of whether to initiate the channel access procedure to occupy the shared channel during the first frame period or share a channel occupancy time initiated by a third UE.

Aspect 10: The method of aspect 9, wherein the groupcast transmission comprises a bitmap, and a bit or time indicator in the bitmap for the first UE indicates whether the first UE is to initiate the channel access procedure to occupy the shared channel during the first frame period or share the channel occupancy time initiated by the third UE.

Aspect 11: The method of any of aspects 9 through 10, wherein the groupcast transmission comprises a field comprising an identifier of the first UE and an indication of whether the first UE is to initiate the channel access procedure to occupy the shared channel during the first frame period or share the channel occupancy time initiated by the third UE.

Aspect 12: The method of any of aspects 1 through 11, further comprising: receiving, in a unicast transmission from a second UE, an indication of whether to initiate the channel access procedure to occupy the shared channel during the first frame period or share a channel occupancy time initiated by the second UE.

Aspect 13: A method for wireless communication at a wireless device, comprising: identifying respective traffic patterns associated with a plurality of UEs; determining, based at least in part on the respective traffic patterns associated with the plurality of UEs, whether each UE of the plurality of UEs is to initiate a channel access procedure to occupy a shared channel during a first frame period of a plurality of frame periods having fixed frame durations established for communication with the plurality of UEs; and transmitting, to the each UE, an indication of whether to initiate the channel access procedure to occupy the shared channel during the first frame period based at least in part on the determining.

Aspect 14: The method of aspect 13, wherein the wireless device comprises a network entity, and wherein transmitting the indication of whether to initiate the channel access procedure to occupy the shared channel during the first frame period comprises: transmitting, in downlink control information, the indication of whether to initiate the channel access procedure to occupy the shared channel during the first frame period or share a channel occupancy time initiated by another UE.

Aspect 15: The method of any of aspects 13 through 14, wherein the wireless device comprises a UE, and wherein transmitting the indication of whether to initiate the channel access procedure to occupy the shared channel during the first frame period comprises: transmitting, in a groupcast transmission, an indication of whether to initiate the channel access procedure to occupy the shared channel during the first frame period or share a channel occupancy time initiated by another UE.

Aspect 16: The method of aspect 15, wherein the groupcast transmission comprises a bitmap, and each bit in the bitmap indicates whether a corresponding UE is to initiate the channel access procedure to occupy the shared channel during the first frame period or share a channel occupancy time initiated by another UE.

Aspect 17: The method of any of aspects 15 through 16, wherein the groupcast transmission comprises a bitmap, and a time indicator in the bitmap indicates whether a corresponding UE is to initiate the channel access procedure to occupy the shared channel during each of one or more frame periods including the first frame period or share channel occupancy times initiated by other UEs.

Aspect 18: The method of any of aspects 15 through 17, wherein the groupcast transmission comprises a field comprising an identifier of the each UE and an indication of whether the each UE is to initiate the channel access procedure to occupy the shared channel during the first frame period or share a channel occupancy time with another UE.

Aspect 19: The method of any of aspects 13 through 18, wherein the wireless device comprises a UE, and wherein transmitting the indication of whether to initiate the channel access procedure to occupy the shared channel during the first frame period comprises: transmitting, to the each UE in a unicast transmission, an indication of whether to initiate the channel access procedure to occupy the shared channel during the first frame period or share a channel occupancy time initiated by another UE.

Aspect 20: A method for wireless communication at a first UE, comprising: identifying, at the first UE, a configuration of a timing of a frame structure for sidelink communication via a shared channel, wherein the frame structure comprises a plurality of frame periods having a fixed frame duration; and communicating during one or more of the plurality of frame periods of the frame structure in accordance with the configuration.

Aspect 21: The method of aspect 20, wherein identifying the configuration of the timing of the frame structure comprises: receiving, from a network entity or a second UE, an indication of the configuration of the timing of the frame structure.

Aspect 22: The method of any of aspects 20 through 21, wherein the configuration of the timing of the frame structure is preconfigured at the first UE.

Aspect 23: The method of any of aspects 20 through 22, further comprising: identifying the configuration of the timing of the frame structure based at least in part on a traffic pattern at the first UE.

Aspect 24: A method for wireless communication at a wireless device, comprising: identifying, based at least in part on a traffic pattern associated with a first UE, a timing of a frame structure for sidelink communication at the first UE via a shared channel, wherein the frame structure comprises a plurality of frame periods having a fixed frame duration; and transmitting, to the first UE, an indication of a configuration of the timing of the frame structure.

Aspect 25: The method of aspect 24, wherein the wireless device comprises a network entity, the method further comprising: determining the traffic pattern at the first UE based at least in part on sidelink communication scheduled at the first UE by the network entity.

Aspect 26: The method of any of aspects 24 through 25, wherein the wireless device comprises a second UE, the method further comprising: receiving, from a network entity or from the first UE, an indication of the traffic pattern at the first UE.

Aspect 27: The method of any of aspects 24 through 26, wherein the wireless device comprises a second UE, and the second UE comprises an anchor UE that is preconfigured, configured via signaling from a network entity, or selected by one or more UEs including the first UE.

Aspect 28: An apparatus for wireless communication at a first UE, comprising a processor; memory coupled with the processor; and instructions stored in the memory and executable by the processor to cause the apparatus to perform a method of any of aspects 1 through 12.

Aspect 29: An apparatus for wireless communication at a first UE, comprising at least one means for performing a method of any of aspects 1 through 12.

Aspect 30: A non-transitory computer-readable medium storing code for wireless communication at a first UE, the code comprising instructions executable by a processor to perform a method of any of aspects 1 through 12.

Aspect 31: An apparatus for wireless communication at a wireless device, comprising a processor; memory coupled with the processor; and instructions stored in the memory and executable by the processor to cause the apparatus to perform a method of any of aspects 13 through 19.

Aspect 32: An apparatus for wireless communication at a wireless device, comprising at least one means for performing a method of any of aspects 13 through 19.

Aspect 33: A non-transitory computer-readable medium storing code for wireless communication at a wireless device, the code comprising instructions executable by a processor to perform a method of any of aspects 13 through 19.

Aspect 34: An apparatus for wireless communication at a first UE, comprising a processor; memory coupled with the processor; and instructions stored in the memory and executable by the processor to cause the apparatus to perform a method of any of aspects 20 through 23.

Aspect 35: An apparatus for wireless communication at a first UE, comprising at least one means for performing a method of any of aspects 20 through 23.

Aspect 36: A non-transitory computer-readable medium storing code for wireless communication at a first UE, the code comprising instructions executable by a processor to perform a method of any of aspects 20 through 23.

Aspect 37: An apparatus for wireless communication at a wireless device, comprising a processor; memory coupled with the processor; and instructions stored in the memory and executable by the processor to cause the apparatus to perform a method of any of aspects 24 through 27.

Aspect 38: An apparatus for wireless communication at a wireless device, comprising at least one means for performing a method of any of aspects 24 through 27.

Aspect 39: A non-transitory computer-readable medium storing code for wireless communication at a wireless device, the code comprising instructions executable by a processor to perform a method of any of aspects 24 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor; and
memory coupled with the processor, wherein the memory comprises instructions executable by the processor to cause the apparatus to:
identify sidelink data to transmit in a first frame period of a plurality of frame periods, the plurality of frame periods having fixed frame durations established for communication by the first UE via a shared channel;
determine whether to initiate a channel access procedure to occupy the shared channel for the first frame period; and
transmit the sidelink data based at least in part on the determining.

2. The apparatus of claim 1, wherein the instructions are further executable by the processor to cause the apparatus to:
monitor the shared channel during a second frame period of the plurality of frame periods for a sidelink transmission from a second UE, wherein determining whether to initiate the channel access procedure to occupy the shared channel during the first frame period is based at least in part on the monitoring.

3. The apparatus of claim 2, wherein the instructions to determine whether to initiate the channel access procedure to occupy the shared channel during the first frame period are executable by the processor to cause the apparatus to:
detect the sidelink transmission from the second UE based at least in part on the monitoring;
determine to share a channel occupancy time initiated by the second UE comprising the second frame period based at least in part on detecting the sidelink transmission; and
refrain from initiating the channel access procedure to occupy the shared channel during the first frame period based at least in part on determining to share the channel occupancy time initiated by the second UE.

4. The apparatus of claim 3, wherein the instructions are further executable by the processor to cause the apparatus to:
receive, in the sidelink transmission, an indication that the sidelink transmission is from the second UE, wherein detecting the sidelink transmission from the second UE is based at least in part on receiving the indication.

5. The apparatus of claim 2, wherein the instructions to determine whether to initiate the channel access procedure to occupy the shared channel during the first frame period are executable by the processor to cause the apparatus to:
determine to initiate the channel access procedure to occupy the shared channel during the first frame period based at least in part on failing to detect the sidelink transmission from the second UE.

6. The apparatus of claim 2, wherein the instructions are further executable by the processor to cause the apparatus to:
receive, from a network entity, the second UE, or a third UE, an indication of a configuration of the second frame period; and
identify a starting boundary of the second frame period based at least in part on receiving the indication of the configuration of the second frame period, wherein the monitoring for the sidelink transmission from the second UE is based at least in part on identifying the starting boundary of the second frame period.

7. The apparatus of claim 2, wherein the sidelink transmission from the second UE comprises a data transmission or a sharing information transmission.

8. The apparatus of claim 1, wherein the instructions are further executable by the processor to cause the apparatus to:
receive, in downlink control information from a network entity, an indication of whether to initiate the channel access procedure to occupy the shared channel during the first frame period or share a channel occupancy time initiated by a second UE.

9. The apparatus of claim 1, wherein the instructions are further executable by the processor to cause the apparatus to:
receive, in a groupcast transmission from a second UE, an indication of whether to initiate the channel access procedure to occupy the shared channel during the first frame period or share a channel occupancy time initiated by a third UE.

10. The apparatus of claim 9, wherein the groupcast transmission comprises a bitmap, and a bit or time indicator in the bitmap for the first UE indicates whether the first UE is to initiate the channel access procedure to occupy the shared channel during the first frame period or share the channel occupancy time initiated by the third UE.

11. The apparatus of claim 9, wherein the groupcast transmission comprises a field comprising an identifier of the first UE and an indication of whether the first UE is to initiate the channel access procedure to occupy the shared channel during the first frame period or share the channel occupancy time initiated by the third UE.

12. The apparatus of claim 1, wherein the instructions are further executable by the processor to cause the apparatus to:
receive, in a unicast transmission from a second UE, an indication of whether to initiate the channel access procedure to occupy the shared channel during the first frame period or share a channel occupancy time initiated by the second UE.

13. An apparatus for wireless communication at a wireless device, comprising:
a processor; and
memory coupled with the processor, wherein the memory comprises instructions executable by the processor to cause the apparatus to:
identify respective traffic patterns associated with a plurality of user equipments (UEs);
determine, based at least in part on the respective traffic patterns associated with the plurality of UEs, whether each UE of the plurality of UEs is to initiate a channel access procedure to occupy a shared channel during a first frame period of a plurality of frame periods, the plurality of frame periods having fixed frame durations established for communication with the plurality of UEs; and
transmit, to the each UE, an indication of whether to initiate the channel access procedure to occupy the shared channel during the first frame period based at least in part on the determining.

14. The apparatus of claim 13, wherein the instructions to transmit the indication of whether to initiate the channel access procedure to occupy the shared channel during the first frame period are executable by the processor to cause the apparatus to:
transmit, in downlink control information, the indication of whether to initiate the channel access procedure to occupy the shared channel during the first frame period or share a channel occupancy time initiated by another UE.

15. The apparatus of claim 13, wherein the instructions to transmit the indication of whether to initiate the channel access procedure to occupy the shared channel during the first frame period are executable by the processor to cause the apparatus to:
transmit, in a groupcast transmission, an indication of whether to initiate the channel access procedure to occupy the shared channel during the first frame period or share a channel occupancy time initiated by another UE.

16. The apparatus of claim 15, wherein the groupcast transmission comprises a bitmap, and each bit in the bitmap indicates whether a corresponding UE is to initiate the channel access procedure to occupy the shared channel during the first frame period or share a channel occupancy time initiated by another UE.

17. The apparatus of claim 15, wherein the groupcast transmission comprises a bitmap, and a time indicator in the bitmap indicates whether a corresponding UE is to initiate the channel access procedure to occupy the shared channel during each of one or more frame periods including the first frame period or share channel occupancy times initiated by other UEs.

18. The apparatus of claim 15, wherein the groupcast transmission comprises a field comprising an identifier of the each UE and an indication of whether the each UE is to initiate the channel access procedure to occupy the shared channel during the first frame period or share a channel occupancy time with another UE.

19. The apparatus of claim 13, wherein the instructions to transmit the indication of whether to initiate the channel access procedure to occupy the shared channel during the first frame period are executable by the processor to cause the apparatus to:
transmit, to the each UE in a unicast transmission, an indication of whether to initiate the channel access procedure to occupy the shared channel during the first frame period or share a channel occupancy time initiated by another UE.

20. An apparatus for wireless communication at a first user equipment (UE), comprising:
a processor; and
memory coupled with the processor, wherein the memory comprises instructions executable by the processor to cause the apparatus to:
identify, at the first UE, a configuration of a timing of a frame structure for sidelink communication via a shared channel, wherein the frame structure comprises a plurality of frame periods having a fixed frame duration; and
communicate during one or more of the plurality of frame periods of the frame structure in accordance with the configuration.

21. The apparatus of claim 20, wherein the instructions to identify the configuration of the timing of the frame structure are executable by the processor to cause the apparatus to:
receive, from a network entity or a second UE, an indication of the configuration of the timing of the frame structure.

22. The apparatus of claim 20, wherein the configuration of the timing of the frame structure is preconfigured at the first UE.

23. The apparatus of claim 20, wherein the instructions are further executable by the processor to cause the apparatus to:
identify the configuration of the timing of the frame structure based at least in part on a traffic pattern at the first UE.

24. An apparatus for wireless communication at a wireless device, comprising:
a processor; and
memory coupled with the processor, wherein the memory comprises instructions executable by the processor to cause the apparatus to:
identify, based at least in part on a traffic pattern associated with a first user equipment (UE), a timing of a frame structure for sidelink communication at the first UE via a shared channel, wherein the frame structure comprises a plurality of frame periods having a fixed frame duration; and
transmit, to the first UE, an indication of a configuration of the timing of the frame structure.

25. The apparatus of claim 24, wherein the wireless device comprises a network entity, and the instructions are further executable by the processor to cause the apparatus to:
determine the traffic pattern associated with the first UE based at least in part on sidelink communication scheduled at the first UE by the network entity.

26. The apparatus of claim 24, wherein the wireless device comprises a second UE, and the instructions are further executable by the processor to cause the apparatus to:
receive, from a network entity or from the first UE, an indication of the traffic pattern at the first UE.

27. The apparatus of claim 24, wherein the wireless device comprises a second UE, and the second UE comprises an anchor UE that is preconfigured, configured via signaling from a network entity, or selected by one or more UEs including the first UE.
